(19) United States
(12) Patent Application Publication
(10) Pub. No.: US 2020/0307197 A1
(43) Pub. Date: Oct. 1, 2020

(54) Head Module

(71) Applicant: Brother Kogyo Kabushiki Kaisha, Nagoya-shi (JP)

(72) Inventors: Keita Hirai, Nagoya-shi (JP); Keita Sugiura, Toyokawa-shi (JP)

(21) Appl. No.: 16/835,714

(22) Filed: Mar. 31, 2020

(30) Foreign Application Priority Data
Apr. 1, 2019 (JP) 2019-069588
Nov. 12, 2019 (JP) 2019-204417

(51) Int. Cl. B41J 2/14

(52) U.S. Cl. CPC B41J 2/1433; B41J 2002/14419

(57) ABSTRACT

A head module includes first individual channels each including a first nozzle orifice; a first supply manifold being in fluid communication with the first individual channels and configured to allow liquid to flow into the first individual channels therefrom; a first return manifold being in fluid communication with the first individual channels and configured to allow liquid not ejected from the first nozzle orifices to flow thereinto; second individual channels each including a second nozzle orifice; a second supply manifold being in fluid communication with the second individual channels and configured to allow liquid to flow into the second individual channels therefrom; a second return manifold being in fluid communication with the second individual channels and configured to allow liquid not ejected from the second nozzle orifices to flow thereinto; and a first bypass path providing fluid communication between the first supply manifold and the second return manifold.

### CROSS-REFERENCE TO RELATED APPLICATIONS

This application claims priority from Japanese Patent Application No. 2019-204417 filed on Nov. 12, 2019, which claims priority from Japanese Patent Application No. 2019-069588, filed on Apr. 12, 2019. The disclosures of these applications are incorporated herein by reference in their entirety.

### TECHNICAL FIELD

Aspects of the disclosure relate to a head module that ejects liquid such as ink.

### BACKGROUND

Some known head module that ejects liquid such as ink is configured to allow liquid to flow from a supply manifold (e.g., a liquid supply chamber) to a pressure chamber (e.g., a pump chamber) being in fluid communication with a nozzle orifice (e.g., a nozzle), via a supply narrowed portion (e.g., a liquid supply channel). The head module is further configured to return liquid not ejected from the nozzle orifice to a return manifold (e.g., a liquid collection chamber) via a return narrowed portion (e.g., a liquid collection channel). That is, such a head module is configured to implement nozzle circulation.

The head module is further configured to implement manifold circulation in which liquid is allowed to flow from the supply manifold (e.g., the liquid supply chamber) to the supply narrowed portion (e.g., the liquid supply channels) via a connection channel and is also allowed to flow from the connection channel to the return narrowed portion (e.g., the liquid collecting channel) via a bypass path (e.g., a bypass gap portion).

### SUMMARY

In the known head module, the supply manifold and the return manifold may be in fluid communication with each other via the bypass path (e.g., the bypass gap portion). Such a configuration may thus aggravate a problem of crosstalk that may be a phenomenon in which liquid ejection from the nozzle orifice becomes instable due to effect of pressure wave propagation from the pressure chamber.

More specifically, for example, a pressure wave generated in a pressure chamber of an individual channel may propagate by two routes. The two routes may include, for example, a first route in which a pressure wave travels through a pressure chamber, a supply narrowed portion, and a supply manifold in this order and a second route in which a pressure chamber travels through a pressure chamber, a nozzle orifice, a return narrowed portion, and a return manifold in this order. The pressure wave traveling via the first route and the pressure wave traveling via the second route may be in the same phase. In a case where the supply manifold and the return manifold that are in fluid communication with the same pressure chamber are in fluid communication with each other via the bypass path, a pressure wave traveling via the first route and a pressure wave traveling via the second route may be merged via the bypass path, thereby amplifying the pressure waves. That is, in the known head module, a crosstalk phenomenon may occur.

Accordingly, aspects of the disclosure provide a head module in which effect of crosstalk caused by pressure wave propagation may be reduced.

According to one or more aspects of the disclosure, a head module may include a plurality of first individual channels, a first supply manifold, a first return manifold, a plurality of second individual channels, a second supply manifold, a second return manifold, and a first bypass path. The first individual channels may each include a first nozzle orifice. The first supply manifold may be in fluid communication with the first individual channels and configured to allow liquid to flow into the first individual channels therefrom. The first return manifold may be in fluid communication with the first individual channels and configured to allow liquid not ejected from the first nozzle orifices to flow thereinto. The second individual channels may each include a second nozzle orifice. The second supply manifold may be in fluid communication with the second individual channels and configured to allow liquid to flow into the second individual channels therefrom. The second return manifold may be in fluid communication with the second individual channels and configured to allow liquid not ejected from the second nozzle orifices to flow thereinto. The first bypass path may provide fluid communication between the first supply manifold and the second return manifold.

### BRIEF DESCRIPTION OF THE DRAWINGS

FIG. 1 is a schematic diagram illustrating a general configuration of a liquid ejection apparatus according to an illustrative embodiment of the disclosure.

FIG. 2 is a schematic top plan view illustrating the general configuration of the liquid ejection apparatus according to the illustrative embodiment of the disclosure.

FIG. 3A is a partially enlarged schematic view of a head module of the liquid ejection apparatus of FIG. 1, illustrating a planar structure of the head module.

FIG. 3B is a partially enlarged schematic view of the head module of the liquid ejection apparatus of FIG. 1, illustrating a cross sectional structure of the head module.

FIG. 4 is a sectional view illustrating a configuration of a first bypass path of the head module according to the illustrative embodiment of the disclosure.

FIG. 5 is a sectional view illustrating a configuration of a second bypass path of the head module according to the illustrative embodiment of the disclosure.

FIG. 6 is a partially enlarged schematic plan view of the head module according to the illustrative embodiment, illustrating a positional relationship between a first supply manifold and a first return manifold, between a second supply manifold and a second return manifold, and between the first bypass path and the second bypass path.

FIG. 7 is a disassembled perspective view of the head module including plates defining the first bypass path and the second bypass path according to the illustrative embodiment of the disclosure.

FIG. 8 is a partially enlarged schematic plan view of a head module according to a first modification of the illustrative embodiment, illustrating a positional relationship between a first supply manifold and a first return manifold, between a second supply manifold and a second return manifold, and between a first bypass path and a second bypass path.

FIG. 9A is a partially enlarged schematic view of a head module according to a second modification of the illustrative embodiment, illustrating a planar structure of the head module.

FIG. 9B is a partially enlarged schematic view of the head module according to the second modification of the illustrative embodiment, illustrating a cross sectional structure of the head module.

FIG. 10 is a schematic sectional view of the head module according to the second modification of the illustrative embodiment, illustrating an example liquid flow route in the head module.

FIG. 11 is a partially enlarged schematic plan view of the head module according to the second modification of the illustrative embodiment, illustrating a positional relationship between a first supply manifold and a first return manifold, between a second supply manifold and a second return manifold, between a third supply manifold and a third return manifold, and between a first bypass path, a second bypass path, and a third bypass path.

FIG. 12A is a partially enlarged schematic view of a head module according to a third modification of the illustrative embodiment, illustrating a planar structure of the head module.

FIG. 12B is a partially enlarged cross sectional schematic view of the head module according to the third modification of the illustrative embodiment, illustrating an example liquid flow route in the head module.

FIG. 13 is a schematic sectional view of the head module according to the third modification of the illustrative embodiment, illustrating a positional relationship between a supply narrowed portion and a return narrowed portion in each individual channel of the head module.

FIG. 14 is a schematic sectional view of a head module according a fourth modification of the illustrative embodiment, illustrating an example liquid flow route in the head module.

FIG. 15 is a schematic sectional view of a head module according a fifth modification of the illustrative embodiment, illustrating an example liquid flow route in the head module.

FIG. 16 is a schematic sectional view of a head module according a sixth modification of the illustrative embodiment, illustrating an example liquid flow route in the head module.

### DETAILED DESCRIPTION

A head module according to an illustrative embodiment will be described with reference to the accompanying drawings. In the description below, the head module may be applied to a liquid ejection apparatus, for example, an ink ejection apparatus that may eject ink onto a recording sheet.

### Configuration of Liquid Ejection Apparatus

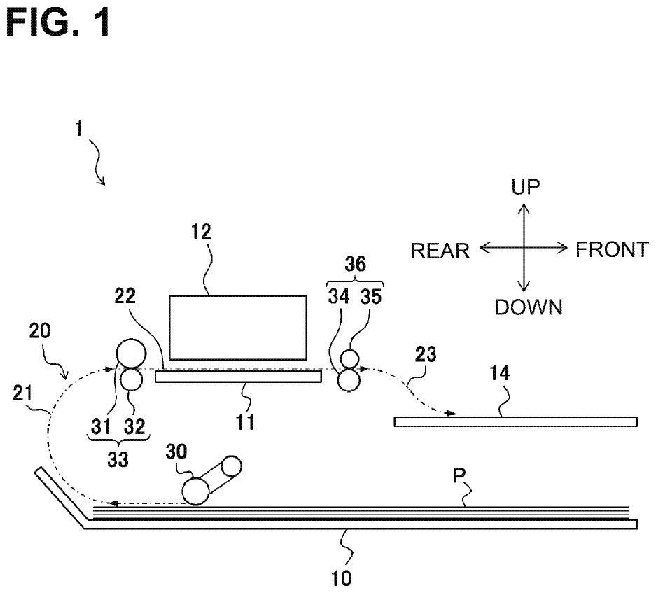

As illustrated in FIG. 1, a liquid ejection apparatus 1 includes a feed tray 10, a platen 11, and a line head 12, which are disposed one above another in this order from below. The feed tray 10 is configured to store one or more recording sheets P. The platen 11 is disposed above the feed tray 10. The platen 11 has longer sides extending along a perpendicular direction that is perpendicular to a direction in which a recording sheet P is conveyed (hereinafter, referred to as the conveyance direction). The platen 11 may be a plate like member. The platen 11 is configured to support from below a recording sheet P being conveyed. The line head 12 is disposed above the platen 11. The line head 12 includes a plurality of head modules 13. The liquid ejection apparatus 1 further includes a discharge tray 14. The discharge tray 14 is disposed in front of the platen 11. The discharge tray 14 is configured to receive one or more recording sheets P having undergone printing.

The liquid ejection apparatus 1 has a sheet conveyance path 20. The sheet conveyance path 20 extends from a rear end of the feed tray 10. The sheet conveyance path 20 connects between the feed tray 10 and the discharge tray 14. The sheet conveyance path 20 includes three sections including a curved path section 21, a straight path section 22, and a last path section 23. The curved path section 21 extends curvedly upward from a rear portion of the feed tray 10 to a vicinity of a rear end of the platen 11. The straight path section 22 extends to a vicinity of a front end of the platen 11 from the end of the curved path section 21 beyond the front end of the platen 11. The last path section 23 extends to the discharge tray 14 from the end of the straight path section 22.

The liquid ejection apparatus 1 further includes a feed roller 30, a conveyance roller 31, and a discharge roller 34, which may constitute a sheet conveyor that conveys a recording sheet P. The sheet conveyor is configured to convey a recording sheet P along the sheet conveyance path 20 from the feed tray 10 to the discharge tray 14 in the conveyance direction.

More specifically, for example, the feed roller 30 is disposed directly above the feed tray 10. The feed roller 30 may contact a recording sheet P from above. The conveyance roller 31 is paired with a pinch roller 32 to constitute a conveyance roller unit 33. The conveyance roller unit 33 is disposed at a vicinity of a downstream end of the curved path section 21 in the conveyance direction. The conveyance roller unit 33 is disposed at a boundary between the curved path section 21 and the straight path section 22 and connect therebetween. The discharge roller 34 is paired with a spur roller 35 to constitute a discharge roller unit 36. The discharge roller unit 36 is disposed at a vicinity of a downstream end of the straight path section 22 in the conveyance direction. The discharge roller unit 36 is disposed at a boundary between the straight path section 22 and the last path section 23 and connect therebetween.

The feed roller 30 is configured to feed a recording sheet P to the conveyance roller unit 33 along the curved path section 21. The conveyance roller unit 33 is configured to convey a recording sheet P fed by the feed roller 30 to the discharge roller unit 36 along the straight path section 22. The head modules 13 are configured to eject ink onto a recording sheet P that is being conveyed along the platen 11 in the straight path section 22, thereby recording an image onto the recording sheet P. The discharge roller unit 36 is configured to convey a recording sheet P having undergone printing to the discharge tray 14.

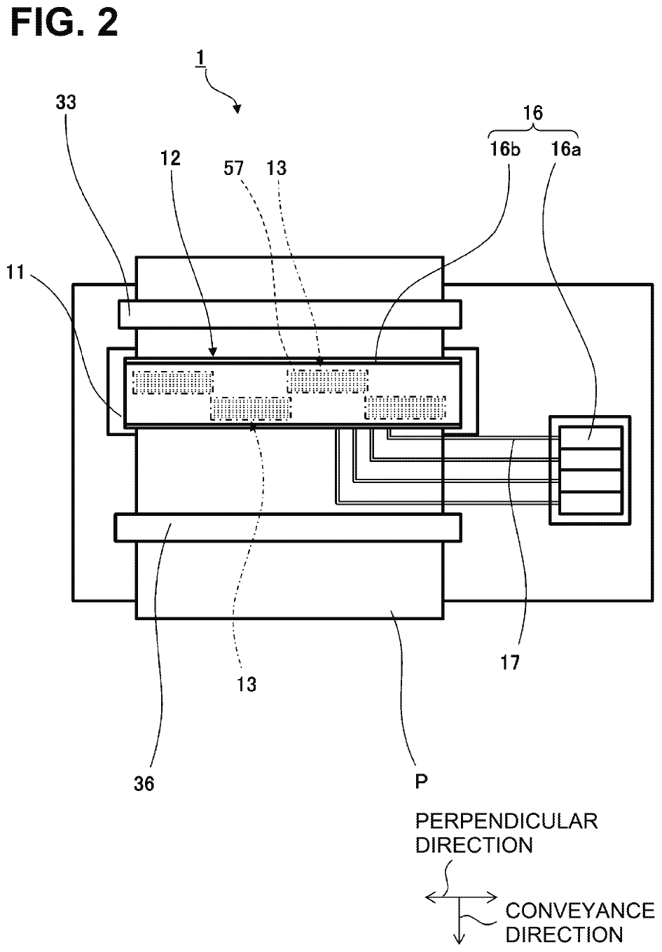

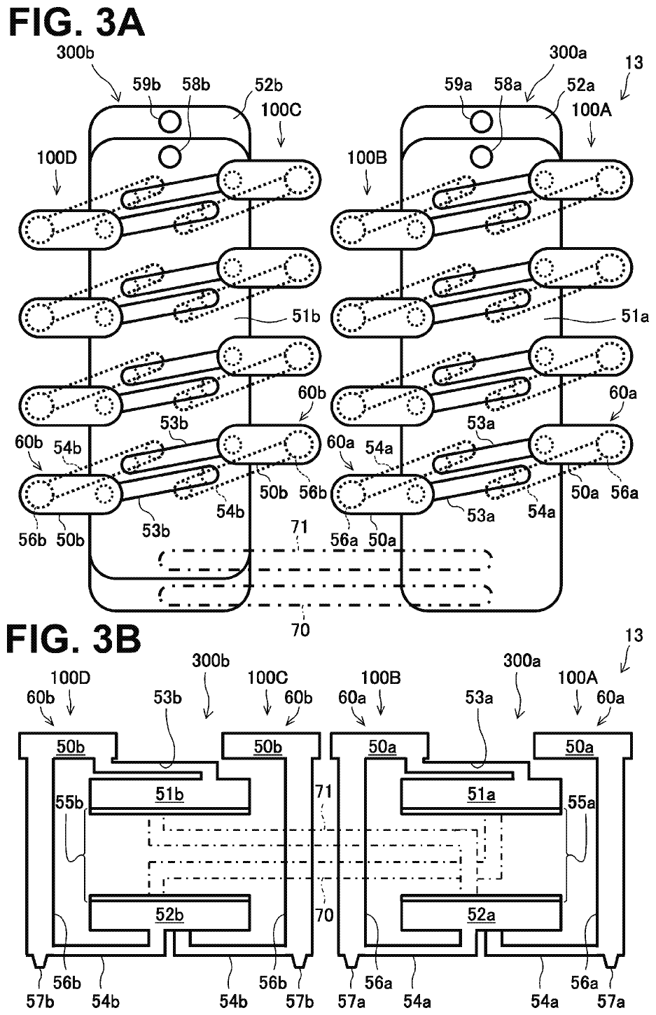

As illustrated in FIG. 2, the line head 12 has a lower surface that may face a surface of a recording sheet P. The line head 12 has a width greater than or equal to a width of a recording sheet P in the perpendicular direction perpendicular to the conveyance direction. The lower surface of the line head 12 has nozzle orifices 57 of individual channels 60a and 60b (refer to FIGS. 3A and 3B). The lower surface of the line head 12 may include a nozzle surface.

The liquid ejection apparatus 1 further includes a plurality of tanks 16. The tanks 16 are connected to corresponding nozzle orifices 57. Each tank 16 includes a sub tank 16b and a storage tank 16a. The sub tank 16b is disposed on the line head 12. The storage tank 16a is connected to the sub tank 16b via a tube 17. The sub tanks 16b and the storage tanks 16a each hold liquid therein. The number of tanks 16 provided corresponds to the number of colors of liquid to be ejected from the nozzle orifices 57. In the illustrative embodiment, for example, four tanks 16 are provided for four colors (e.g., black, yellow, cyan, and magenta) of liquid. Thus, the line head 12 may eject different kinds or types (e.g., colors) of liquid.

As described above, the line head 12 is fixed to a particular position and is configured to eject liquid from appropriate ones of the nozzle orifices 57. The sheet conveyor is configured to, in response to such ejection, convey a recording sheet P in the conveyance direction to record an image onto the recording sheet P.

In the illustrative embodiment, the head modules 13 constitute the line head 12. Nevertheless, in other embodiments, for example, the head modules 13 may constitute a serial head instead of the line head 12.

### Configuration of Head Module

All of the head modules 13 may have the same configuration, and therefore, one of the head modules 13 will be described in detail. Referring to FIGS. 3A and 3B, a configuration of a head module 13 will be described. The head module 13 includes a piezoelectric plate that is disposed above first pressure chambers 50a and second pressure chambers 50b. The piezoelectric plate is configured to apply pressure to liquid in the first pressure chambers 50a or liquid in the second pressure chambers 50b. For purposes of convenience, in FIGS. 3A and 3B, the piezoelectric plate is not illustrated. In FIG. 3B, for easy understanding of a positional relationship between a first bypass path 70 and a second bypass path 71, an area in which the first bypass path 70 and the second bypass path 71 are defined, that is, portions of plates in which a first damper portion 55a and a second damper portion 55b are defined, are enlarged.

In one example, the portions and channels of the head module 13 may be formed by lamination of a plurality of plates that have undergone etching (half etching) or cutting. In another example, the portions and channels of the head module 13 may be formed by lamination of a plurality of resin-made plates molded in respective particular shapes.

FIGS. 3A and 3B are partially enlarged views of the head module 13 having four different nozzle rows including a first nozzle row 100A, a second nozzle row 100B, a third nozzle row 100C, and a fourth nozzle row 100D. In the illustrative embodiment, the first nozzle row 100A and the second nozzle row 100B belong to a first island portion 300a including a first supply manifold 51a and a first return manifold 52a. The third nozzle row 100C and the fourth nozzle row 100D belong to a second island portion 300b including a second supply manifold 51b and a second return manifold 52b. In the illustrative embodiment, the first island portion 300a and the second island portion 300b may be positioned next to each other.

A supply manifold with which first individual channels 60a are in fluid communication may be referred to as a first supply manifold 51a, and a return manifold with which the first individual channels 60a are in fluid communication may be referred to as a first return manifold 52a. A supply manifold with which second individual channels 60b are in fluid communication may be referred to as a second supply manifold 51b, and a return manifold with which the second individual channels 60b are in fluid communication may be referred to as a second return manifold 52b. An island portion may be a unit including a supply manifold and a return manifold each overlapping corresponding pressure chambers of respective particular individual channels when viewed in plan from the nozzle surface.

Individual channels constituting the first nozzle row 100A belonging to the first island portion 300a and individual channels constituting the second nozzle row 100B belonging to the first island portion 300a may have the same configuration, and therefore, those individual channels will be referred to as the first individual channels 60a without distinguishing therebetween. Hereinafter, the description will be thus provided with respect to one of the first individual channels 60a. Individual channels constituting the third nozzle row 100C belonging to the second island portion 300b and individual channels constituting the fourth nozzle row 100D belonging to the second island portion 300b may have the same configuration, and therefore, those individual channels will be referred to as the second individual channels 60b without distinguishing therebetween. Hereinafter, the description will be thus provided with respect to one of the second individual channels 60b.

A first individual channel 60a includes a first pressure chamber 50a, a first descender 56a, and a first nozzle orifice 57a. The first descender 56a is in fluid communication with the first pressure chamber 50a. The first nozzle orifice 57a is in fluid communication with the first descender 56a and is configured to allow a liquid droplet to be ejected therefrom. A direction toward which the surface of the head module 13 that has the first nozzle orifice 57a (i.e., the nozzle surface) faces may be defined as a down direction, and a direction opposite to the down direction may be defined as an up direction. With respect to the defined directions, the first pressure chamber 50a is disposed above the first descender 56a. The piezoelectric plate (e.g., a piezoelectric body) is disposed above the first pressure chambers 50a. The piezoelectric plate is configured to apply pressure to liquid in appropriate ones of the first pressure chambers 50a at a certain timing. More specifically, for example, in response to application of a voltage to the piezoelectric plate at a certain timing, a volume of the piezoelectric plate changes to apply pressure to liquid in appropriate ones of the first pressure chambers 50a, thereby enabling the head module 13 to eject a liquid droplet from one or more first nozzle orifices 57a.

The first individual channel 60a includes a first supply narrowed portion 53a. The first individual channel 60a is in fluid communication with the first supply manifold 51a via the first supply narrowed portion 53a. The first individual channel 60a further includes a first return narrowed portion 54a. The first individual channel 60a is in fluid communication with the first return manifold 52a via the first return narrowed portion 54a. More specifically, for example, the first supply manifold 51a and the first pressure chamber 50a of the first individual channel 60a are in fluid communication with each other via the first supply narrowed portion 53a whose flow path diameter is narrowed. The first nozzle orifice 57a of the first individual channel 60a and the first return manifold 52a are in fluid communication with each other via the first return narrowed portion 54a whose flow path diameter is narrowed.

In the liquid ejection apparatus 1, liquid is supplied from a corresponding tank 16 to flow into the first supply manifold 51a via a first inlet 58a. Liquid is then supplied to the first pressure chamber 50a of the first individual channel 60a via the first supply narrowed portion 53a. In response to application of pressure to liquid in the first pressure chamber 50a, liquid is led to the first nozzle orifice 57a through the first descender 56a, thereby being ejected from the first nozzle orifice 57a in a droplet form. Liquid not ejected from the first nozzle orifice 57a is caused to flow to the first return manifold 52a via a first return narrowed portion 54a. Liquid in the first return manifold 52a is then returned to the corresponding tank 16 via a first outlet 59a. As described above, nozzle circulation may be implemented with respect to the first individual channel 60a. Such nozzle circulation may be implemented with each first individual channel 60a belonging to the first island portion 300a.

The first supply manifold 51a is at a positive pressure for allowing liquid to flow into the first pressure chamber 50a. The first return manifold 52a is at a negative pressure for allowing liquid not ejected from the first nozzle orifice 57a to flow thereinto.

The first supply manifold 51a and the first return manifold 52a overlap each other when viewed in plan from the nozzle surface. As described above, the direction toward which the nozzle surface of the head module 13 faces may be defined as the down direction, and the direction opposite to the down direction may be defined as the up direction. With reference to the defined directions, the first supply manifold 51a is disposed above the first return manifold 52a. The head module 13 further includes a first damper portion 55a between the first supply manifold 51a and the first return manifold 52a. The first damper portion 55a is configured to reduce effect of a pressure wave propagating to the first supply manifold 51a from the first pressure chamber 50a via the first supply narrowed portion 53a. The first damper portion 55a is further configured to reduce effect of a pressure wave propagating to the first return manifold 52a from the first pressure chamber 50a via a first return narrowed portion 54a.

Each of the second individual channels 60b may have the same configuration as the first individual channel 60a and therefore one of the second individual channels 60b will be representatively briefly described. A second individual channel 60b includes a second pressure chamber 50b, a second descender 56b, and a second nozzle orifice 57b. The second descender 56b is in fluid communication with the second pressure chamber 50b. The second nozzle orifice 57b is in fluid communication with the second descender 56b and is configured to allow a liquid droplet to be ejected therefrom. The second individual channel 60b is connected to the second supply manifold 51b via a corresponding second return narrowed portion 54b and is also connected to the second return manifold 52b via a corresponding second return narrowed portion 54b.

When viewed in plan from the nozzle surface, the second supply manifold 51b and the second return manifold 52b overlap each other. The head module 13 further includes a second damper portion 55b between the second supply manifold 51b and the second return manifold 52b. In the illustrative embodiment, the first damper portion 55a and the second damper portion 55b are defined by a plurality of, for example, two plates such as a first damper plate 80 and a second damper plate 81 having hollow portions for defining damper spaces.

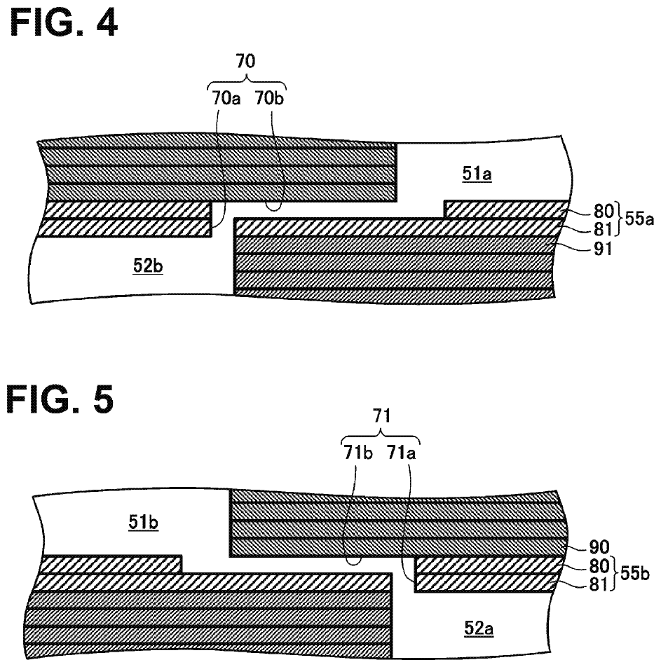

Although the first individual channel 60a and the second individual channel 60b belong to respective different island portions, the first individual channel 60a and the second individual channel 60b are connected to each other by a liquid circulation path that may be the first bypass path 70. More specifically, for example, as illustrated in FIG. 3B, the first supply manifold 51a and the second return manifold 52b are connected to each other via the first bypass path 70, thereby allowing some liquid in the first supply manifold 51a to flow into the second return manifold 52b. Such a configuration may thus enable liquid to circulate between the first supply manifold 51a and the second return manifold 52b (hereinafter, such liquid circulation may be referred to as the “manifold circulation”). Referring to FIG. 4, a configuration of the first bypass path 70 will be described.

As illustrated in FIG. 4, in the illustrative embodiment, the first bypass path 70 may be defined by the first damper plate 80 and the second damper plate 81 that define the first damper portion 55a and the second damper portion 55b. The first damper plate 80 and the second damper plate 81 may serve as walls defining the first supply manifold 51a and the second return manifold 52b. The first damper plate 80 may define a bottom surface of the first supply manifold 51a. The second damper plate 81 may define an upper surface of the second return manifold 52b.

More specifically, for example, the first damper plate 80 further has a first flow path 70b that may be a cutaway portion defined in a particular area other than the area having the first damper portion 55a and the second damper portion 55b. The first flow path 70b is in fluid communication with the first supply manifold 51a.

The second damper plate 81 further has a first bypass hole 70a that may be a through hole defined in a particular area other than the area having the first damper portion 55a and the second damper portion 55b. The first bypass hole 70a penetrates the second damper plate 81 in an up-down direction (e.g., a plate laminating direction). The first bypass hole 70a has one opening end and the other opening end. The first bypass hole 70a is in fluid communication with the second return manifold 52b via the one opening end and in fluid communication with the first flow path 70b via the other opening end. When viewed in plan from the nozzle surface, the first flow path 70b is positioned overlapping the first supply manifold 51a and the first bypass hole 70a.

In one example, the first bypass path 70 may be defined by lamination of the first damper plate 80 and the second damper plate 81, each of which has undergone etching or cutting. In another example, the first bypass path 70 may be defined by lamination of the first damper plate 80 and the second damper plate 81, each of which may be a resin molded plate having a particular shape. Pressure to be applied to liquid flowing through the first bypass path 70 may be easily controlled by changing the shapes and sizes of the first bypass hole 70a and the first flow path 70b as appropriate. In one example, the first flow path 70b may be a narrow groove or slit extending from the first supply manifold 51a toward the second return manifold 52b in the first damper plate 80. In another example, when viewed in plan from the nozzle surface, the first flow path 70b may be a through hole. The through hole may have a diameter size enough to overlap each of the first supply manifold 51a and the first bypass hole 70a and penetrate the first damper plate 80 in the up-down direction.

In the head module 13, the second supply manifold 51b and the first return manifold 52a are in fluid communication with each other via the second bypass path 71, thereby allowing some liquid in the second supply manifold 51b to flow into the first return manifold 52a. Such a configuration may thus enable liquid to circulate between the second supply manifold 51b and the first return manifold 52a (i.e., the manifold circulation).

Referring to FIG. 5, a configuration of the second bypass path 71 will be described.

As illustrated in FIG. 5, in the illustrative embodiment, the second bypass path 71 may be defined by the first damper plate 80 and the second damper plate 81 that define the first damper portion 55a and the second damper portion 55b. The first damper plate 80 and the second damper plate 81 may also serve as walls defining the second supply manifold 51b and the first return manifold 52a. The first damper plate 80 may define a bottom surface of the second supply manifold 51b. The second damper plate 81 may define an upper surface of the first return manifold 52a.

More specifically, for example, the first damper plate 80 further has a second flow path 71b that may be a cutaway portion defined in a particular area other than the area having the first damper portion 55a, the second damper portion 55b, and the first bypass path 70. The second flow path 71b is in fluid communication with the second supply manifold 51b.

The second damper plate 81 further has a second bypass hole 71a that may be a through hole defined in a particular area other than the area having the first damper portion 55a, the second damper portion 55b, and the first bypass path 70. The second bypass hole 71a penetrates the second damper plate 81 in the up-down direction (e.g., the plate laminating direction). The second bypass hole 71a has one opening end and the other opening end. The second bypass hole 71a is in fluid communication with the first return manifold 52a via the one opening end and in fluid communication with the second flow path 71b via the other opening end. When viewed in plan from the nozzle surface, the second flow path 71b is positioned overlapping the second supply manifold 51b and the second bypass hole 71a.

In a similar manner to the first bypass path 70, in one example, the second bypass path 71 may be defined by lamination of the first damper plate 80 and the second damper plate 81, each of which has undergone etching or cutting. In another example, the second bypass path 71 may be formed by lamination of the first damper plate 80 and the second damper plate 81, each of which may be a resin molded plate having a particular shape. Pressure to be applied to liquid flowing through the second bypass path 71 may be easily controlled by changing the shapes and sizes of the second bypass hole 71a and the second flow path 71b as appropriate. In one example, the second flow path 71b may be a narrow groove or slit extending from the second supply manifold 51b toward the first return manifold 52a in the first damper plate 80. In another example, when viewed in plan from the nozzle surface, the second flow path 71b may be a through hole. The through hole may have a diameter size enough to overlap each of the second supply manifold 51b and the second bypass hole 71a and penetrate the first damper plate 80 in the up-down direction.

As described above, in the head module 13 according to the illustrative embodiment, a supply manifold and a return manifold that belong to respective different island portions are in fluid communication with each other to allow to implement the manifold circulation therebetween. Such a configuration may thus prevent a pressure wave propagating from the first pressure chamber 50a through the first supply manifold 51a and another pressure wave propagating from the first pressure chamber 50a through the first return manifold 52a from merging each other via the bypass path (e.g., the first bypass path 70 or the second bypass path 71), thereby reducing effect of crosstalk. Such a configuration may also a pressure wave propagating from the second pressure chamber 50b through the second supply manifold 51b and another pressure wave propagating from the second pressure chamber 50b through the second return manifold 52b from merging each other via the bypass path (e.g., the first bypass path 70 or the second bypass path 71), thereby reducing effect of crosstalk.

Nevertheless, the configuration of the head module 13 according to the illustrative embodiment may allow a pressure wave propagating from the first pressure chamber 50a through the first supply manifold 51a and another pressure wave propagating from the second pressure chamber 50b through the second return manifold 52b to merge each other via the first bypass path 70. Further, the configuration of the head module 13 according to the illustrative embodiment may allow a pressure wave propagating from the second pressure chamber 50b through the second supply manifold 51b and another pressure wave propagating from the first pressure chamber 50a through the first return manifold 52a to merge each other via the second bypass path 71.

As described above, however, the first individual channel 60a and the second individual channel 60b belong to respective different island portions. That is, the first individual channel 60a is included in one nozzle row (e.g., the first nozzle row 100A or the second nozzle row 100B) and the second individual channel 60b is included in another nozzle row (e.g., the third nozzle rows 100C and the fourth nozzle rows 100D). Thus, a possibility that the first individual channel 60a ejects a liquid droplet at the same timing as the second individual channel 60b ejects a liquid droplet may be less than a possibility that individual channels included in the same nozzle row eject liquid droplets, respectively, at the same timing.

Consequently, a possibility that a pressure wave propagating through the first supply manifold 51a is in the same phase as a pressure wave propagating through the second return manifold 52b may be reduced, thereby being less susceptible to effect of crosstalk even if the pressure waves merge with each other. In addition, a possibility that a pressure wave propagating through the second supply manifold 51b is in the same phase as a pressure wave propagating through the first return manifold 52a may be reduced, thereby being less susceptible to effect of crosstalk even if the pressure waves merge with each other.

As described above, the first bypass path 70 and the second bypass path 71 are both defined in the first damper plate 80 and in the second damper plate 81. Thus, the first bypass path 70 and the second bypass path 71 may need to be laid out as appropriate. Further, based on the layout of the first bypass path 70 and the second bypass path 71, the first supply manifold 51a, the first return manifold 52a, the second supply manifold 51b, and the second return manifold 52b may also need to be laid out as appropriate.

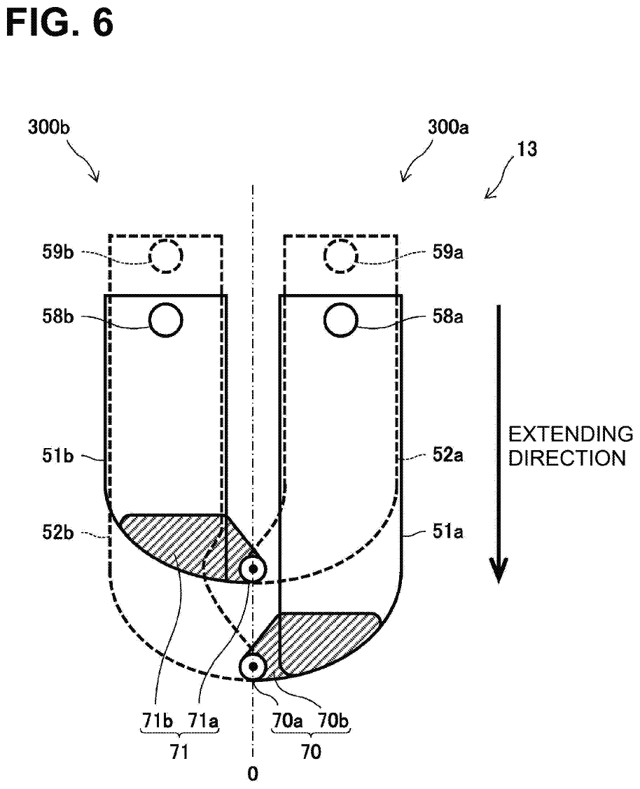

Referring to FIG. 6, a description will be provided on a positional relationship between the first supply manifold 51a and the first return manifold 52a both included in the first island portion 300a, between the second supply manifold 51b and the second return manifold 52b both included in the second island portion 300b, and between the first bypass path 70 and the second bypass path 71. In FIG. 6, the first supply manifold 51a and the second supply manifold 51b are indicated by a solid line, and the first return manifold 52a and the second return manifold 52b are indicated by a dashed line. In FIG. 6, the first individual channels 60a and the second individual channels 60b are not illustrated.

As illustrated in FIG. 6, in the head module 13 of the liquid ejection apparatus 1, when viewed in plan from the nozzle surface, the first supply manifold 51a and the first return manifold 52a overlap each other and extend in the same extending direction. Nevertheless, the first supply manifold 51a and the first return manifold 52a have respective different lengths in the extending direction. When viewed in plan from the nozzle surface, the second supply manifold 51b and the second return manifold 52b overlap each other and extend in the same extending direction. Nevertheless, the second supply manifold 51b and the second return manifold 52b have respective different lengths in the extending direction.

The first supply manifold 51a and the second return manifold 52b each have a front end portion and a base end portion opposite to the front end portion in the extending direction. The front end portion of the first supply manifold 51a is positioned at substantially the same position as the front end portion of the second return manifold 52b.The first bypass path 70 thus connects between the front end portion of the first supply manifold 51a and the front end portion of the second return manifold 52b. The first supply manifold 51a has a first inlet 58a at the base end portion thereof. The second return manifold 52b has a second outlet 59b at the base end portion thereof.

The second supply manifold 51b and the first return manifold 52a each have a front end portion and a base end portion opposite to the front end portion in the extending direction. The front end portion of the second supply manifold 51b is positioned at substantially the same position as the front end portion of the first return manifold 52a. The second bypass path 71 thus connects between the front end portion of the second supply manifold 51b and the front end portion of the first return manifold 52a. The second supply manifold 51b has a second inlet 58b at the base end portion. The first return manifold 52a has a first outlet 59a at the base end portion.

The first bypass path 70 is farther from the first outlet 59a than the second bypass path 71 is from the first outlet 59a in the extending direction. Such an arrangement may enable the first bypass path 70 and the second bypass path 71 not to overlap each other.

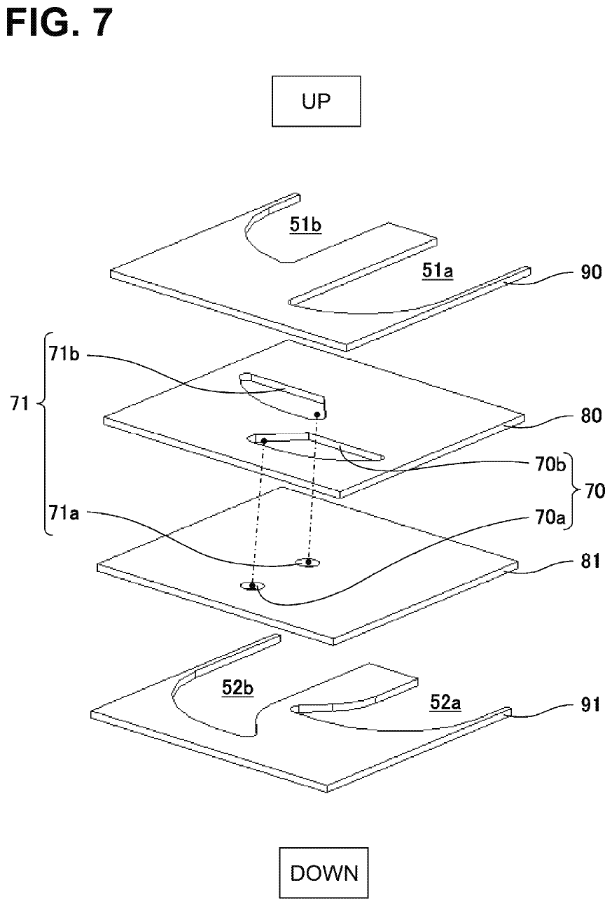

Referring to FIG. 7, the first bypass path 70 and the second bypass path 71 will be described in detail.

As illustrated in FIG. 7, a plate 90 and the first damper plate 80 are laminated one above the other. The first damper plate 80 may thus define the bottom surface of the first supply manifold 51a and the bottom surface of the second supply manifold 51b. The plate 90 has a cutaway portion having a shape corresponding to the first supply manifold 51a. The first damper plate 80 has a cutaway portion serving as the first flow path 70b. The first supply manifold 51a and the first bypass path 70 are in fluid communication with each other in an overlapping area of the cutaway portion of the plate 90 and the cutaway portion of the first damper plate 80. The plate 90 has another cutaway portion having a shape corresponding to the second supply manifold 51b. The first damper plate 80 has another cutaway portion serving as the second flow path 71b. The second supply manifold 51b and the second bypass path 71 are in fluid communication with each other in an overlapping area of the cutaway portion of the plate 90 and the cutaway portion of the first damper plate 80.

As illustrated in FIG. 7, the second damper plate 81 and a plate 91 are laminated one above the other. The second damper plate 81 may thus define the upper surface of the first return manifold 52a and the upper surface of the second return manifold 52b. The plate 91 has a cutaway portion having a shape corresponding to the first return manifold 52a. The second damper plate 81 has a cutaway portion serving as the second bypass hole 71a. The first return manifold 52a and the second bypass path 71 are in fluid communication with each other in an overlapping area of the cutaway portion of the plate 91 and the cutaway portion of the second damper plate 81. The plate 91 has another cutaway portion having a shape corresponding to the second return manifold 52b. The second damper plate 81 has another cutaway portion serving as the first bypass hole 70a. The second return manifold 52b and the first bypass path 70 are in fluid communication with each other in an overlapping area of the cutaway portion of the plate 91 and the cutaway portion of the second damper plate 81.

The first damper plate 80 has sector-shaped holes each having an arc curved correspondingly to the front end portion of a corresponding one of the first supply manifold 51a and the second supply manifold 51b. The first flow path 70b and the second flow path 71b each having a sector shape are defined by lamination of the plate 90, the first damper plate 80, and the second damper plate 81.

The first flow path 70b is positioned such that an end portion of the arc of the first flow path 70b closer to the second island portion 300b overlaps the first bypass hole 70a of the second damper plate 81.

Such a configuration may allow liquid held in the first supply manifold 51a to flow into the first flow path 70b having an opening larger than the first bypass hole 70a. Liquid is then allowed to further flow toward the end portion of the arc of the first flow path 70b overlapping the first bypass hole 70a. A width of the first flow path 70b gradually decreases toward the end portion of the arc having the first bypass hole 70a. With this configuration, after liquid flows into the first flow path 70b, pressure applied to liquid flowing in the first flow path 70b is controlled before liquid reaches the first bypass hole 70a, and then liquid flows into the second return manifold 52b via the first bypass hole 70a.

The second flow path 71b is positioned such that an end portion of the arc of the second flow path 71b closer to the first island portion 300a overlaps the second bypass hole 71a of the second damper plate 81.

Such a configuration may allow liquid held in the second supply manifold 51b to flow into the second flow path 71b having an opening larger than the second bypass hole 71a. Liquid is then allowed to further flow toward the end portion of the arc of the second flow path 71b overlapping the second bypass hole 71a. In a similar manner to the first flow path 70b, a width of the second flow path 71b gradually decreases toward the end portion of the arc having the second bypass hole 71a. With this configuration, after liquid flows into the second flow path 71b, pressure applied to liquid flowing in the second flow path 71b is controlled before liquid reaches the second bypass hole 71a, and then liquid flows into the first return manifold 52a via the second bypass hole 71a.

As illustrated in FIG. 6, when viewed in plan from the nozzle surface, the center of the first bypass hole 70a of the first bypass path 70 is on the center line O between and parallel to the first supply manifold 51a and the second return manifold 52b. When viewed in plan from the nozzle surface, the center of the second bypass hole 71a of the second bypass path 71 is on the center line O extending between and parallel to the second supply manifold 51b and the first return manifold 52a. With this configuration, when viewed in plan from the nozzle surface, a combined shape of the first supply manifold 51a and the first flow path 70b of the first bypass path 70 and the shape of the second return manifold 52b are substantially symmetric with respect to the center line O. Further, when viewed in plan from the nozzle surface, a combined shape of the second supply manifold 51b and the second flow path 71b of the second bypass path 71 and the shape of the first return manifold 52a are substantially symmetric with respect to the center line O. Such a configuration may enable a smooth connection of the manifolds belonging to the respective different island portions.

As illustrated in FIG. 6, in the head module 13 according to the illustrative embodiment, the first supply manifold 51a and the second supply manifold 51b have the first inlet 58a and the second inlet 58b, respectively, at their base end portions opposite to the front end portions thereof having the first bypass path 70 and the second bypass path 71, respectively, in the extending direction. Further, the first return manifold 52a and the second return manifold 52b have the first outlet 59a and the second outlet 59b, respectively, at the base end portions opposite to the front end portions thereof in the extending direction. Nevertheless, the locations of the first inlet 58a, the second inlet 58b, the first outlet 59a, and the second outlet 59b are not limited to the specific example such as the base end portions. In other embodiments, for example, the first inlet 58a, the second inlet 58b, the first outlet 59a, and the second outlet 59b might not necessarily be defined on respective end portions on the same side but may be defined on respective end portions on different sides in the respective corresponding manifolds. In accordance with a layout and/or shape of a channel through which liquid that is supplied into the first supply manifold 51a via the first inlet 58a, a channel through which liquid that is supplied into the second supply manifold 51b via the second inlet 58b, a channel through which liquid that flows out of the first return manifold 52a via the first outlet 59a, and a channel through which liquid that flows out of the second return manifold 52b via the second outlet 59b, the positions of the first inlet 58a, the second inlet 58b, the first outlet 59a, and the second outlet 59b may be determined as appropriate.

### First Modification

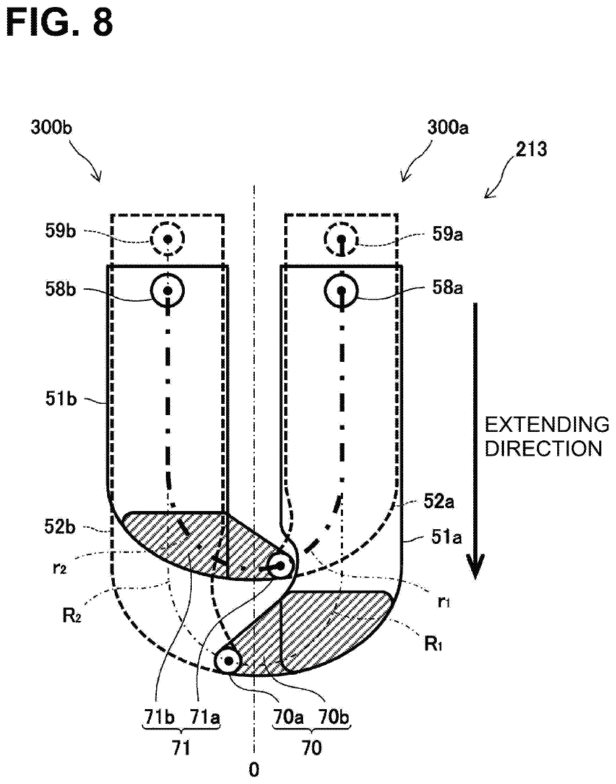

Referring to FIG. 8, a head module 213 according to a first modification will be described. In FIG. 8, a first supply manifold 51a and a second supply manifold 51b are indicated by a solid line, and a first return manifold 52a and a second return manifold 52b are indicated by a dashed line. In FIG. 8, first individual channels 60a belonging to a first island portion 300a and second individual channels 60b belonging to a second island portion 300b are not illustrated.

In the head module 13 according to the illustrative embodiment, the center of the first bypass hole 70a of the first bypass path 70 and the center of the second bypass hole 71a of the second bypass path 71 are on the center line O.

Nevertheless, in the head module 213 according to the first modification, layout of the first supply manifold 51a, the first return manifold 52a, the second supply manifold 51b, and the second return manifold 52b is different from the layout of those in the head module 13 according to the illustrative embodiment.

More specifically, for example, as illustrated in FIG. 8, a first bypass path 70 and a second bypass path 71 are positioned such that the center of a first bypass hole 70a and the center of a second bypass hole 71a are apart from each other in a direction perpendicular to the extending direction.

In view of prevention of liquid leakage, the first bypass path 70 and the second bypass path 71 may need to be apart from each other by a certain distance. In a case where the center of the first bypass hole 70a and the center of the second bypass hole 71a are on the same straight line extending in the extending direction in like manner with the first bypass hole 70a and the second bypass hole 71a of the head module 13, the first bypass hole 70a and the second bypass hole 71a need to be apart from each other in the extending direction. Thus, in the head module 13, the first supply manifold 51a and the second return manifold 52b may need to be further elongated in the extending direction to locate the first bypass hole 70a and the second bypass hole 71a in such a manner, resulting in increase of the size of the head module 13 in the extending direction.

Nevertheless, in the head module 213 according to the first modification, the center of the first bypass hole 70a and the center of the second bypass hole 71a are apart from each other in the direction perpendicular to the extending direction. Thus, the first bypass hole 70a and the second bypass hole 71a might not necessarily be apart from each other by a certain distance in the extending direction, thereby reducing the size of the liquid ejection apparatus 1.

In the head module 213 according to the first modification, a distance R₁ from the center of a first inlet 58a of the first supply manifold 51a to the center of the first bypass hole 70a is equal to a distance R₂ from the center of a second outlet 59b of the second return manifold 52b to the center of the first bypass hole 70a. Further, a distance r₁ from the center of a first outlet 59a of the first return manifold 52a to the center of the second bypass hole 71a is equal to a distance r₂ from the center of a second inlet 58b of the second supply manifold 51b to the center of the second bypass hole 71a. Such a configuration may thus equalize channel resistance to liquid between a manifold belonging to the first island portion 300a and a manifold belonging to the second island portion 300b when the manifold circulation is implemented. Thus, an equal pressure may be applied to nozzle orifices 57 of the first individual channels 60a belonging to the first island portion 300a and nozzle orifices 57 of the second individual channels 60b belonging to the second island portion 300b. Consequently, such a configuration may reduce occurrences of meniscus breaks and variations in a meniscus shape due to locations, thereby reducing liquid ejection variations.

As illustrated in FIG. 8, in the head module 213 according to the first modification, a base end of the first supply manifold 51a and a base end of the second supply manifold 51b are substantially aligned with each other in the perpendicular direction. A base end of the first return manifold 52a and a base end of the second return manifold 52b are substantially aligned with each other in the perpendicular direction. Nevertheless, the base end of the first supply manifold 51a and the base end of the second supply manifold 51b might not necessarily be aligned with each other in the perpendicular direction. Further, the base end of the first return manifold 52a and the base end of the second return manifold 52b might not necessarily be aligned with each other in the perpendicular direction. However, the configuration in which the base end of the first supply manifold 51a and the base end of the second supply manifold 51b are aligned with each other in the perpendicular direction and the base end of the first return manifold 52a and the base end of the second return manifold 52b are aligned with each other in the perpendicular direction may enable the nozzle orifices 57 to be arranged with highly population as compared with the configuration in which the base end of the first supply manifold 51a and the base end of the second supply manifold 51b are not aligned with each other in the perpendicular direction and the base end of the first return manifold 52a and the base end of the second return manifold 52b are not aligned with each other in the perpendicular direction.

In the head module 213, the distance R₁ from the center of the first inlet 58a of the first supply manifold 51a to the center of the first bypass hole 70a may be equal to the distance R₂ from the center of the second outlet 59b of the second return manifold 52b to the center of the first bypass hole 70a. Further, the distance r₁ from the center of the first outlet 59a of the first return manifold 52a to the center of the second bypass hole 71a may also be equal to the distance r₂ from the center of the second inlet 58b of the second supply manifold 51b to the center of the second bypass hole 71a.

### Second Modification

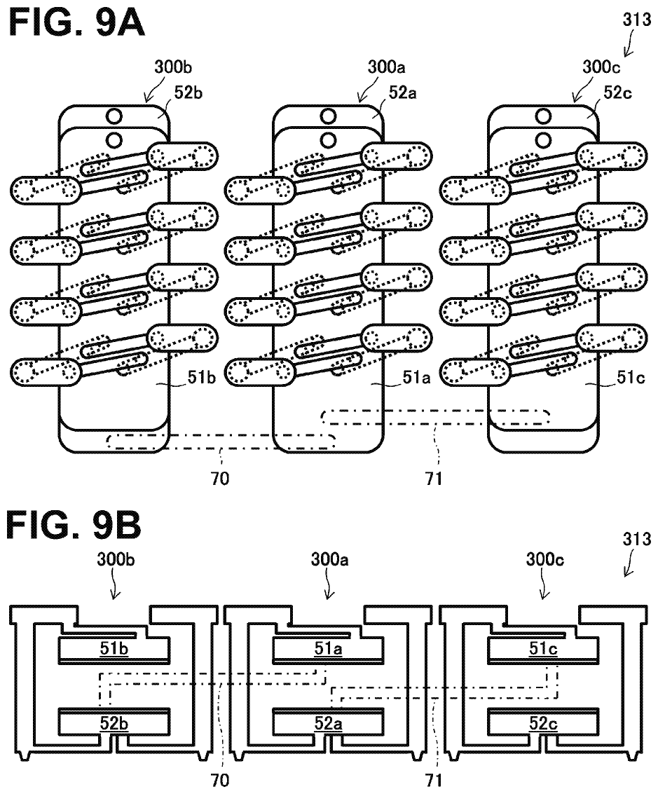

Referring to FIGS. 9A and 9B, one example of a head module 313 according to a second modification will be described. The head module 313 includes a piezoelectric plate. Nevertheless, for purposes of convenience, in FIG. 9A and 9B, the piezoelectric plate is not illustrated. In FIG. 9B, for easy understanding of a positional relationship between a first bypass path 70 and a second bypass path 71, an area in which the first bypass path 70 and the second bypass path 71 are defined, that is, portions of plates in which a first damper portion 55a and a second damper portion 55b are defined, are enlarged.

In the head module 13 according to the illustrative embodiment, a supply manifold belonging to one of the first island portion 300a and the second island portion 300b and a return manifold belonging to the other of the first island portion 300a and the second island portion 300b are in fluid communication with each other to enable the manifold circulation between the first island portion 300a and the second island portion 300b. Nevertheless, in the one example, as illustrated in FIGS. 9A and 9B, the head module 313 according to the second modification includes a first island portion 300a, a second island portion 300b, and a third island portion 300c. A first supply manifold 51a belonging to the first island portion 300a is in fluid communication with a second return manifold 52b belonging to the second island portion 300b. A first return manifold 52a belonging to the first island portion 300a is in fluid communication with a third supply manifold 51c belonging to the third island portion 300c.

The third island portion 300c includes the third supply manifold 51c and a third return manifold 52c, each of which is in fluid communication with individual channels. As illustrated in FIGS. 9A and 9B, the third island portion 300c is located across the first island portion 300a from the second island portion 300b. The third island portion 300c may have the same configuration as the first island portion 300a and the second island portion 300b, and therefore, the detailed description of the third island portion 300c is omitted. In the head module 313 according to the second modification, the first supply manifold 51a of the first island portion 300a is in fluid communication with the second return manifold 52b of the second island portion 300b via a first bypass path 70. The first return manifold 52a of the first island portion 300a is in fluid communication with the third supply manifold 51c of the third island portion 300c via a second bypass path 71.

A possibility that individual channels belonging to the respective different island portions (e.g., the first island portion 300a, the second island portion 300b, and the third island portion 300c) eject liquid droplets at the same timing may be less than a possibility that individual channels belonging to the same island portion eject liquid droplets at the same timing.

Thus, a possibility that a pressure wave propagating through the first supply manifold 51a is in the same phase as a pressure wave propagating through the second return manifold 52b may be reduced, thereby being less susceptible to effect of crosstalk even if the pressure waves merge with each other. In addition, a possibility that a pressure wave propagating through the third supply manifold 51c is in the same phase as a pressure wave propagating through the first return manifold 52a may be reduced, thereby being less susceptible to effect of crosstalk even if the pressure waves merge with each other.

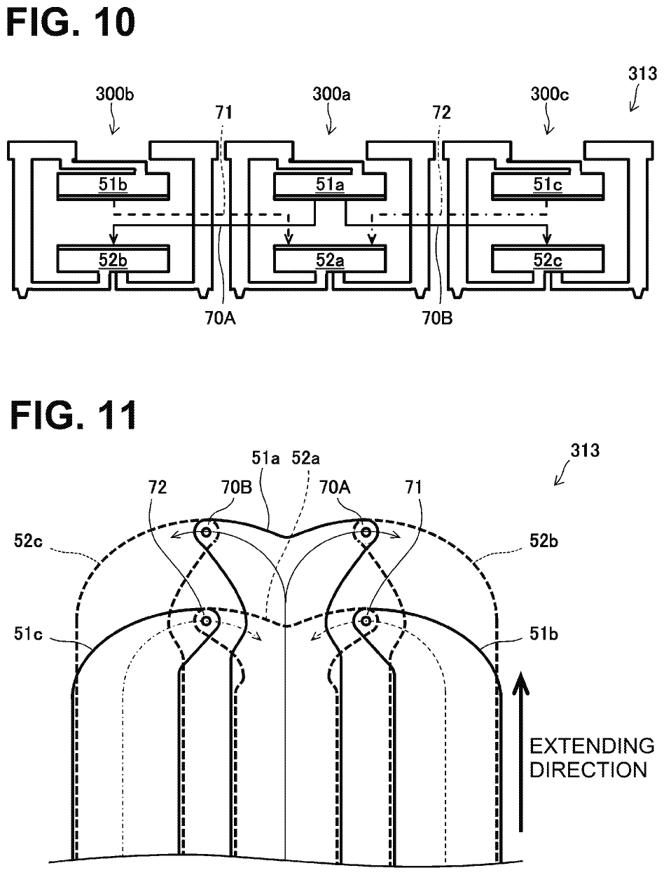

In the one example of the second modification, the head module 313 includes three island portions. More specifically, for example, the first supply manifold 51a of the first island portion 300a is in fluid communication with the second return manifold 52b of the second island portion 300b, and the first return manifold 52a of the first island portion 300a is in fluid communication with the third supply manifold 51c of the third island portion 300c. Nevertheless, the routing of the bypass paths connecting the supply manifolds and the return manifolds between the first island portion 300a, the second island portion 300b, and the third island portion 300c is not limited to the above example. In another example, as illustrated in FIG. 10, in a head module 313, supply manifolds and return manifolds are in fluid communication with each other such that liquid can flow by routes indicated by direction arrows. In FIG. 10, each liquid flow direction is indicated by an arrow in the sectional view illustrating the configuration of the head module 313.

More specifically, for example, a first supply manifold 51a belonging to a first island portion 300a is in fluid communication with a second return manifold 52b belonging to a second island portion 300b via a first bypass path 70A and is also in fluid communication with a third return manifold 52c belonging to a third island portion 300c via a first bypass path 70B. A second supply manifold 51b belonging to the second island portion 300b is in fluid communication with a first return manifold 52a belonging to the first island portion 300a via a second bypass path 71. A third supply manifold 51c belonging to the third island portion 300c is in fluid communication with the first return manifold 52a belonging to the first island portion 300a via a third bypass path 72. In FIG. 10, the liquid flow direction in which liquid flows through the first bypass path 70A or through the first bypass path 70B is indicated by a solid line. The liquid flow direction in which liquid flows through the second bypass path 71 is indicated by a dashed line. The liquid flow direction in which liquid flows through the third bypass path 72 is indicated by a dotted-and-dashed line.

In the head module 313 having such a configuration, a possibility that a pressure wave propagating through the first supply manifold 51a, a pressure wave propagating through the second return manifold 52b, and a pressure wave propagating through the third return manifold 52c are in the same phase may be reduced, thereby being less susceptible to effect of crosstalk even if the pressure waves merge with each other. In addition, a possibility that a pressure wave propagating through the second supply manifold 51b, a pressure wave propagating through the third supply manifold 51c, and a pressure wave propagating through the first return manifold 52a are in the same phase may be reduced, thereby being less susceptible to effect of crosstalk even if the pressure waves merge with each other.

For allowing liquid to flow by the routes as illustrated in FIG. 10, for example, the head module 313 may have a configuration illustrated in FIG. 11.

In FIG. 11, the first supply manifold 51a, the second supply manifold 51b, and the third supply manifold 51c are indicated by a solid line, and the first return manifold 52a, the second return manifold 52b, and the third return manifold 52c are indicated by a dashed line. First individual channels 60a belonging to the first island portion 300a, second individual channels 60b belonging to the second island portion 300b, third individual channels 60c belonging to the third island portion 300c are not illustrated.

The first supply manifold 51a has a front end portion in the extending direction. The front end portion of the first supply manifold 51a bifurcates into a right portion and a left portion. The right portion of the front end portion of the first supply manifold 51a in the extending direction is substantially aligned with a front end portion of the second return manifold 52b in the extending direction with respect to the perpendicular direction. The first bypass path 70A connects between the front end portion of the first supply manifold 51a and the front end portion of the second return manifold 52b. The left portion of the front end portion of the first supply manifold 51a in the extending direction is substantially aligned with a front end portion of the third return manifold 52c in the extending direction with respect to the perpendicular direction. The first bypass path 70B connects between the front end portion of the first supply manifold 51a and the front end portion of the third return manifold 52c.

The first return manifold 52a has a front end portion in the extending direction. The front end portion of the first return manifold 52a bifurcates into a right portion and a left portion. A front end portion of the second supply manifold 51b in the extending direction is substantially aligned with the right portion of the front end portion of the first return manifold 52a in the extending direction with respect to the perpendicular direction. The second bypass path 71 connects between the front end portion of the second supply manifold 51b and the front end portion of the first return manifold 52a. A front end portion of the third supply manifold 51c in the extending direction is substantially aligned with the left portion of the front end portion of the first return manifold 52a in the extending direction. The third bypass path 72 connects between the front end portion of the third supply manifold 51c and the front end portion of the first return manifold 52a.

As illustrated in FIG. 11, in the first supply manifold 51a, liquid flows separately into the right portion and the left portion of the front end portion of the first supply manifold 51a. Liquid flowing in the right portion of the front end portion of the first supply manifold 51a then flows into the second return manifold 52b via the first bypass path 70A. Liquid flowing in the left portion of the front end portion of the first supply manifold 51a then flows into the third return manifold 52c via the first bypass path 70B. Liquid flowing in the second supply manifold 51b flows into the right portion of the front end portion of the first return manifold 52a via the second bypass path 71. Liquid flowing in the third supply manifold 51c flows into the left portion of the front end portion of the first return manifold 52a via the third bypass path 72. Liquid flowing into the first return manifold 52a via the second bypass path 71 and via the third bypass path 72 is gathered in the first return manifold 52a and flows in a direction opposite to the liquid flow direction in which liquid flows in the first supply manifold 51a.

### Third Modification

In the head module 13 according to the illustrative embodiment, the head module 213 according to the first modification, and the head modules 313 according to the second modification, the first island portion 300a includes the first supply manifold 51a and the first return manifold 52a and the second island portion 300b includes the second supply manifold 51b and the second return manifold 52b. In such a configuration, a bypass path may provide fluid communication between a supply manifold of one island portion and a return manifold of another island portion located next to the one island portion. Such a configuration may reduce effect of crosstalk in a case where a pressure wave propagating through the supply manifold and a pressure wave propagating through the return manifold merge with each other.

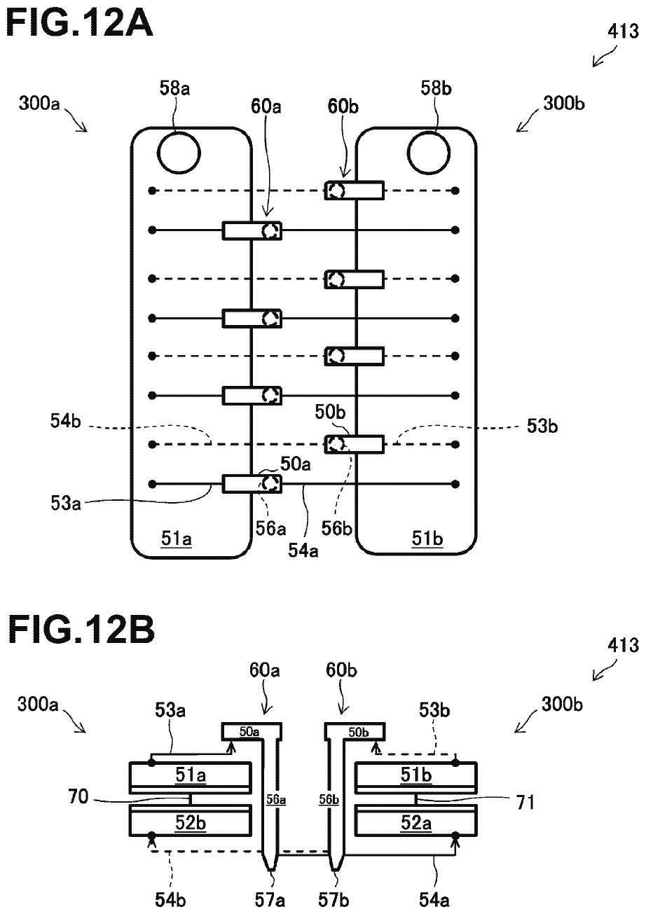

According to a third modification, in a head module 413, a first supply manifold 51a belongs to a first island portion 300a and a first return manifold 52a belongs to a second island portion 300b. The first island portion 300a and the second island portion 300b are located next to and connected to each other via return narrowed portions. Such a configuration may achieve the same effect as that achieved by the head module 13 according to the illustrative embodiment, the head module 213 according to the first modification, and the head modules 313 according to the second modification. Referring to FIGS. 12A and 12B, a configuration of the head module 413 according to the third modification will be described. In FIGS. 12A and 12B, for easy understanding a relationship between individual channels, each island portion may include a single nozzle row. In FIG. 12B, a liquid flow direction in which liquid flows through a first individual channel 60a is indicated by a solid line, and a liquid flow direction in which liquid flows through a second individual channel 60b is indicated by a dashed line.

In the head module 13 according to the illustrative embodiment, the head module 213 according to the first modification, and the head modules 313 according to the second modification, the first supply manifold 51a belonging to the first island portion 300a and the second return manifold 52b belonging to the second return manifold 52b are in fluid communication with each other via the first bypass path 70, and some liquid in the first supply manifold 51a flows into the second return manifold 52b to implement the manifold circulation. Nevertheless, in the head module 413 according to the third modification, liquid in the first supply manifold 51a belonging to the first island portion 300a is allowed to flow into the first return manifold 52a belonging to the second island portion 300b via a first individual channel 60a. Some remaining liquid in the second supply manifold 51b that has not flowed into a second individual channel 60b is allowed to flow into the first return manifold 52a via the second bypass path 71. Liquid in the first return manifold 52a is then returned to a corresponding tank 16 via a second outlet 59b. As described above, the nozzle circulation and the manifold circulation may be implemented in the head module 413.

More specifically, for example, as illustrated in FIGS. 12A and 12B, the head module 413 includes the first island portion 300a including first individual channels 60a and the second island portion 300b including second individual channels 60b. The first island portion 300a and the second island portion 300b are positioned next to each other.

When viewed in plan from a nozzle surface of the head module 413, the first supply manifold 51a and the second return manifold 52b overlap each other in the first island portion 300a and the second supply manifold 51b and the first return manifold 52a overlap each other in the second island portion 300b.

The first supply manifold 51a is in fluid communication with a first pressure chamber 50a of a first individual channel 60a via a first supply narrowed portion 53a. The first pressure chamber 50a is in fluid communication with one end of a first descender 56a. The first descender 56a has a first nozzle orifice 57a at the other end thereof. Liquid is allowed to flow into the first pressure chamber 50a from the first supply manifold 51a via a first supply narrowed portion 53a. The head module 413 further includes a piezoelectric plate (i.e., a piezoelectric body) above the first pressure chamber 50a. The piezoelectric plate is configured to apply pressure to liquid in the first pressure chamber 50a at a certain timing. Thus, the head module 413 may eject a liquid droplet from the first nozzle orifice 57a corresponding to the first pressure chamber 50a at a certain timing. Liquid not ejected from the first nozzle orifice 57a is allowed to flow into the first return manifold 52a belonging to the second island portion 300b via the first return narrowed portion 54a. Some remaining liquid in the second supply manifold 51b that has not flowed into the second individual channel 60b is allowed to flow into the first return manifold 52a via the second bypass path 71. Liquid in the first return manifold 52a is then returned to a corresponding tank 16 via a second outlet 59b. As described above, the nozzle circulation and the manifold circulation may be implemented in the head module 413.

The second supply manifold 51b is in fluid communication with a second pressure chamber 50b of a second individual channel 60b via a second supply narrowed portion 53b. The second pressure chamber 50b is in fluid communication with one end of a second descender 56b. The second descender 56b has a second nozzle orifice 57b at the other end thereof. Liquid is allowed to flow into the second pressure chambers 50b from the second supply manifold 51b via a second supply narrowed portions 53b. The piezoelectric plate (i.e., a piezoelectric body) is disposed above the second pressure chamber 50b. The piezoelectric plate is configured to apply pressure to liquid in the second pressure chambers 50b at a certain timing. Thus, the head module 413 may eject a liquid droplet from the second nozzle orifice 57b corresponding to the second pressure chamber 50b at a certain timing. Liquid not ejected from the second nozzle orifice 57b is allowed to flow into the second return manifold 52b belonging to the first island portion 300a via the second return narrowed portion 54b. Some remaining liquid in the first supply manifold 51a that has not flowed into the first individual channel 60a is allowed to flow into the second return manifold 52b via the first bypass path 70. Liquid in the second return manifold 52b is then returned to a corresponding tank 16 via a first outlet 59a. As described above, the nozzle circulation and the manifold circulation may be implemented in the head module 413.

In the head module 413 according to the third modification, the first individual channel 60a belonging to the first island portion 300a is in fluid communication with the first supply manifold 51a belonging to the same first island portion 300a via the first supply narrowed portion 53a and is also in fluid communication with the first return manifold 52a belonging to the second island portion 300b located next to the first island portion 300a via the first return narrowed portion 54a. As compared with a configuration in which both of the first supply manifold 51a and the first return manifold 52a belong to the same first island portion 300a, the configuration according to the third modification may enable the head module 413 to have a longer first return narrowed portion 54a, thereby applying a desired level of resistance to liquid flowing through the first return narrowed portion 54a.

In a similar manner to the first individual channel 60a, the second individual channel 60b belonging to the second island portion 300b is in fluid communication with the second supply manifold 51b belonging to the same second island portion 300b via the second supply narrowed portion 53b and is also in fluid communication with the second return manifold 52b belonging to the first island portion 300a located next to the second island portion 300b via the second return narrowed portion 54b. As compared with a configuration in which both of the second supply manifold 51b and the second return manifold 52b belong to the same second island portion 300b, the configuration according to the third modification may enable the head module 413 to have a longer second return narrowed portion 54b, thereby applying a desired level of resistance to liquid flowing through the second return narrowed portion 54b.

As described above, in the head module 413, two different island portions may be bidirectionally connected to each other via the first return narrowed portions 54a and the second return narrowed portions 54b. Nevertheless, instead of such a configuration, for example, each island portion may be unidirectionally connected to a respective adjacent island portion located to one side thereof. More specifically, for example, a first individual channel 60a belonging to a first island portion 300a may be in fluid communication with a first return manifold 52a belonging to a second island portion 300b located to the one side of and next to the first island portion 300a via a first return narrowed portion 54a. A second individual channel 60b belonging to the second island portion 300b may be in fluid communication with a second return manifold 52b belonging to another island portion located to the one side of and next to the second island portion 300b via a second return narrowed portion 54b. In such a case, however, for implementing the nozzle circulation and the manifold circulation of liquid flowing through the first individual channel 60a and liquid flowing through the second individual channel 60b, at least three island portions and three individual channels belonging to respective corresponding island portions.

According to the third modification, in the head module 413, as described above, liquid flowing through the first individual channel 60a and liquid flowing through the second individual channel 60b are allowed to bidirectionally flow between the first island portion 300a and the second island portion 300b to implement the nozzle circulation and the manifold circulation. With this configuration, the nozzle circulation and the manifold circulation may be achieved by only at least two island portions and two individual channels belonging to the respective island portions. Such a configuration may decrease required number of individual channels and enable the first individual channel 60a and the second individual channel 60b to be located close to each other. Consequently, the head module 413 of the third modification may include individual channels at highly populated density.

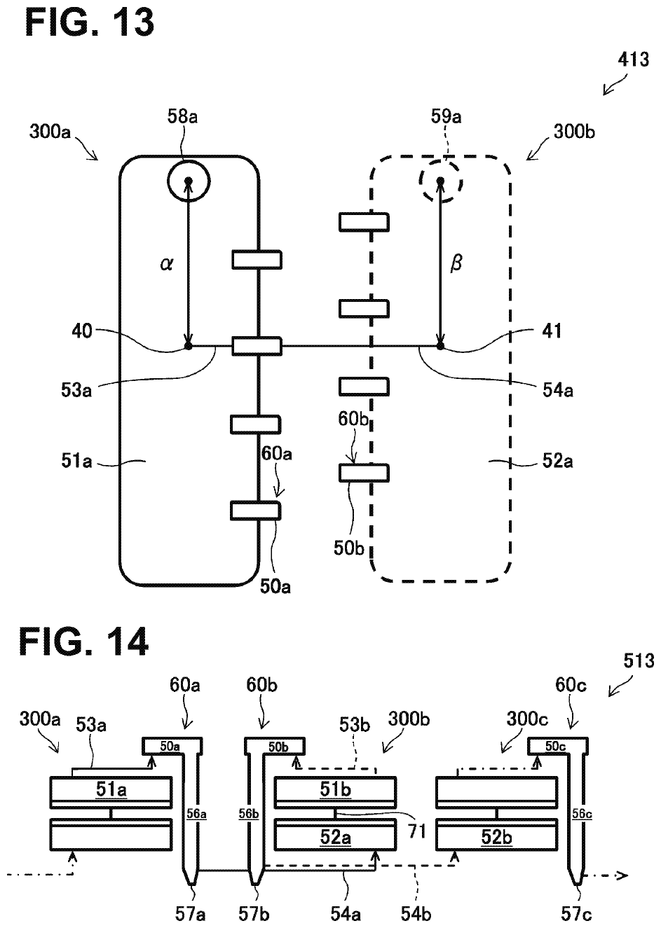

In the head module 413 of the third modification, for example, a supply narrowed portion and a return narrowed portion may be positioned as illustrated in FIG. 13. A plurality of first individual channels 60a are aligned in a longer direction of a first island portion 300a. Hereinafter, one of the first individual channels 60a will be described representatively.

The first supply manifold 51a and the first supply narrowed portion 53a of the first individual channel 60a are in fluid communication with each other via a first connecting portion 40. The first return manifold 52a and the first return narrowed portion 54a of the first individual channel 60a are in fluid communication with each other via a second connecting portion 41. As illustrated in FIG. 13, a distance α from the center of a first inlet 58a to the first connecting portion 40 is equal to a distance β from the center of a first outlet 59a to the second connecting portion 41.

The first supply manifold 51a is at a positive pressure for allowing liquid to flow into the first individual channel 60a. The first return manifold 52a is at a negative pressure for allowing liquid not ejected from the first nozzle orifice 57a to flow thereinto. As illustrated in FIG. 13, the distance α and the distance β are equal to each other under such conditions. Thus, in the head module 413 according to the third modification, pressure to be applied to liquid at a first nozzle orifice 57a located between the first supply narrowed portion 53a and the first return narrowed portion 54a in the liquid flow route may be controlled to an appropriate level of pressure.

Consequently, the head module 413 may eject liquid straightly toward a recording sheet P from the first nozzle orifice 57a.

The second individual channels 60b are arranged in the second island portion 300b in a row extending in the same direction as the direction in which the first individual channels 60a are arranged. The second connecting portion 41 is disposed between adjacent second individual channels 60b. In one example, as illustrated in FIG. 13, the first individual channels 60a and the second individual channels 60b are arranged in respective rows and in a staggered pattern. Such an arrangement may thus enable the first supply narrowed portion 53a and the first return narrowed portion 54a to be in line with each other when the head module 413 is viewed in plan.

As described above, the second connecting portion 41 is disposed between adjacent second individual channels 60b. With this arrangement, the first return narrowed portion 54a might not obstruct the arrangement of the second individual channels 60b in the second island portion 300b.

In the specific example illustrated in FIG. 13, the first supply narrowed portion 53a and the first return narrowed portion 54a are in line with each other. Nevertheless, the positional relationship between the first supply narrowed portion 53a and the first return narrowed portion 43a is not limited to such a specific example as long as the distance α and the distance β are equal to each other.

### Fourth Modification

Referring to FIG. 14, a configuration of a head module 513 according to a fourth modification will be described. In the head module 513, each individual channel belonging to a respective island portion is in fluid communication with a corresponding return manifold belonging to another respective island portion located to the one side of and adjacent to the island portion to which each of the individual channels belongs.

More specifically, for example, the head module 513 includes a first supply manifold 51a belonging to a first island portion 300a, and a second supply manifold 51b and a first return manifold 52a both belonging to a second island portion 300b. The head module 513 further includes a second return manifold 52b belonging to a third island portion 300c including third individual channels 60c (only one of the third individual channels 60c is illustrated in FIG. 14). Each of the third individual channels 60c includes a third pressure chamber 50c, a third descender 56c, and a third nozzle orifice 57c. When viewed in plan from a nozzle surface of the head module 513, the first supply manifold 51a and a return manifold overlap each other in the first island portion 300a and the second supply manifold 51b and the first return manifold 52a overlap each other in the second island portion 300b. When viewed in plan from the nozzle surface, a supply manifold and the second return manifold 52b overlap each other in the third island portion 300c.

In the first island portion 300a, the first supply manifold 51a is in fluid communication with a first pressure chamber 50a of a first individual channel 60a via a first supply narrowed portion 53a. The first pressure chamber 50a is in fluid communication with one end of a first descender 56a. The first descender 56a has a first nozzle orifice 57a at the other end thereof. Liquid is allowed to flow into the first pressure chamber 50a from the first supply manifold 51a via the first supply narrowed portion 53a and to be ejected in droplet form from the first nozzle orifice 57a at a certain timing. Liquid not ejected from the first nozzle orifice 57a is allowed to flow into the first return manifold 52a belonging to the second island portion 300b via the first return narrowed portion 54a. Some remaining liquid in the second supply manifold 51b that has not flowed into a second individual channel 60b is allowed to flow into the first return manifold 52a via the second bypass path 71. Liquid in the first return manifold 52a is then returned to a corresponding tank 16 via a second outlet 59b. As described above, the nozzle circulation and the manifold circulation may be implemented in the head module 513.

In the second island portion 300b, the second supply manifold 51b is in fluid communication with a second pressure chamber 50b of a second individual channel 60b via a second supply narrowed portion 53b. The second pressure chamber 50b is in fluid communication with one end of a second descender 56b. The second descender 56b has a second nozzle orifice 57b at the other end thereof. Liquid is allowed to flow into the second pressure chamber 50b from the second supply manifold 51b via the second supply narrowed portion 53b and to be ejected in droplet form from the second nozzle orifice 57b at a certain timing. Liquid not ejected from the second nozzle orifice 57b is allowed to flow into the second return manifold 52b belonging to the third island portion 300c via the second return narrowed portion 54b. Liquid in the second return manifold 52b is then returned to a corresponding tank 16 via a third outlet.

According to the fourth modification, the nozzle circulation and the manifold circulation may be implemented between two individual channels (e.g., between the first individual channel 60a and the second individual channel 60b). Nevertheless, in another example, the nozzle circulation and the manifold circulation may be implemented between three individual channels (e.g., between the first individual channel 60a, the second individual channel 60b, and the third individual channel 60c).

### Fifth Modification

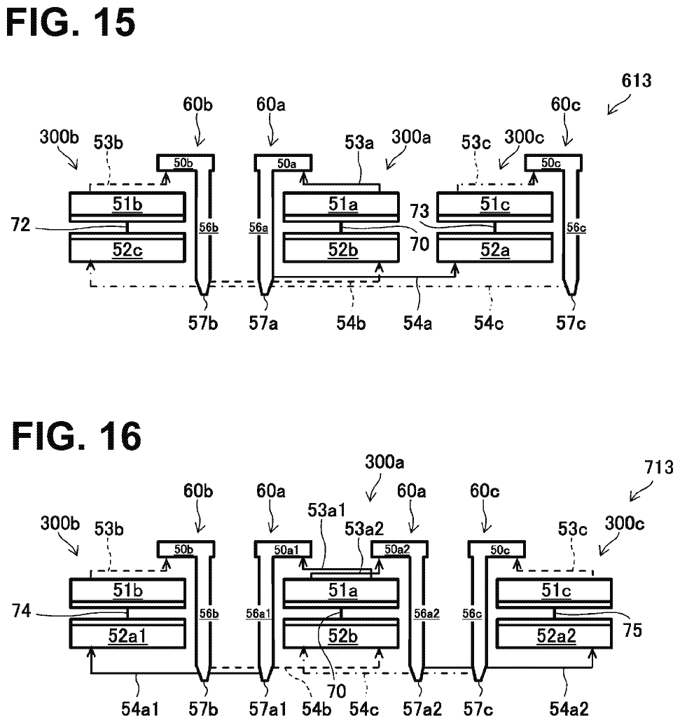

Referring to FIG. 15, a configuration of a head module 613 according to a fifth modification will be described. The head module 613 is configured to implement the nozzle circulation and the manifold circulation between three individual channels. In the head module 613, a third island portion 300c including third individual channels 60c (only one of the third individual channels 60c is illustrated) is disposed to the one side (e.g., to the right) of a first island portion 300a including first individual channels 60a (only one of the first individual channels 60a is illustrated). A second island portion 300b including second individual channels 60b (only one of the second individual channels 60b is illustrated) is disposed to the other side (e.g., to the left) of the first island portion 300a.

When viewed in plan from a nozzle surface of the head module 613, in the first island portion 300a of the head module 613, a first supply manifold 51a and a second return manifold 52b overlap each other and are in fluid communication with each other via a first bypass path 70. In the second island portion 300b, a second supply manifold 51b and a third return manifold 52c overlap each other and are in fluid communication with each other via a third bypass path 72. In the third island portion 300c, a third supply manifold 51c and a first return manifold 52a overlap each other and are in fluid communication with each other via a fourth bypass path 73.

In the first island portion 300a, the first supply manifold 51a is in fluid communication with a first pressure chamber 50a of a first individual channel 60a via a first supply narrowed portion 53a. The first pressure chamber 50a is in fluid communication with one end of a first descender 56a. The first descender 56a has a first nozzle orifice 57a at the other end thereof. Liquid is allowed to flow into the first pressure chamber 50a from the first supply manifold 51a via the first supply narrowed portion 53a and to be ejected in droplet form from the first nozzle orifice 57a at a certain timing. Liquid not ejected from the first nozzle orifice 57a is allowed to flow into the first return manifold 52a belonging to the third island portion 300c via the first return narrowed portion 54a. Some remaining liquid in the third supply manifold 51c that has not flowed into a third individual channel 60c is allowed to flow into the first return manifold 52a via the fourth bypass path 73. Liquid in the first return manifold 52a is then returned to a corresponding tank 16 via a third outlet. As described above, the nozzle circulation and the manifold circulation may be implemented in the head module 613.

In the third island portion 300c, the third supply manifold 51c is in fluid communication with a third pressure chamber 50c of a third individual channel 60c via a third supply narrowed portion 53c. The third pressure chamber 50c is in fluid communication with one end of a third descender 56c. The third descender 56c has a third nozzle orifice 57c at the other end thereof. Liquid is allowed to flow into the third pressure chamber 50c from the third supply manifold 51c via the third supply narrowed portion 53c and to be ejected in droplet form from the third nozzle orifice 57c at a certain timing. Liquid not ejected from the third nozzle orifice 57c is allowed to flow into the third return manifold 52c belonging to the second island portion 300b via the third return narrowed portion 54c. Some remaining liquid in the second supply manifold 51b that has not flowed into a second individual channel 60b is allowed to flow into the third return manifold 52c via the third bypass path 72. Liquid in the third return manifold 52c is then returned to a corresponding tank 16 via a second outlet 59b. As described above, the nozzle circulation and the manifold circulation may be implemented in the head module 613.

In the second island portion 300b, the second supply manifold 51b is in fluid communication with a second pressure chamber 50b of a second individual channel 60b via a second supply narrowed portion 53b. The second pressure chamber 50b is in fluid communication with one end of a second descender 56b. The second descender 56b has a second nozzle orifice 57b at the other end thereof. Liquid is allowed to flow into the second pressure chamber 50b from the second supply manifold 51b via the second supply narrowed portion 53b and to be ejected in droplet form from the second nozzle orifice 57b at a certain timing. Liquid not ejected from the second nozzle orifice 57b is allowed to flow into the second return manifold 52b belonging to the first island portion 300a via the second return narrowed portion 54b. Some remaining liquid in the first supply manifold 51a that has not flowed into the first individual channel 60a is allowed to flow into the second return manifold 52b via the first bypass path 70. Liquid in the second return manifold 52b is then returned to a corresponding tank 16 via a first outlet 59a. As described above, the nozzle circulation and the manifold circulation may be implemented in the head module 613.

According to the fifth modification, the head module 613 may implement the nozzle circulation and the manifold circulation between three individual channels (e.g., between the first individual channel 60a, the second individual channel 60b, and the third individual channel 60c), and reduce effect of crosstalk caused by pressure wave propagation.

### Sixth Modification

The one example configuration has been described in the fifth modification in which the nozzle circulation and the manifold circulation may be implemented between three individual channels (e.g., between the first individual channel 60a, the second individual channel 60b, and the third individual channel 60c). Nevertheless, such a configuration is not limited to the one example configuration. Referring to FIG. 16, another example of such a configuration according to a sixth modification will be described.

When viewed in plan from a nozzle surface of a head module 713, in a first island portion 300a, a first supply manifold 51a and a second return manifold 52b overlap each other and are in fluid communication with each other via a first bypass path 70. In a second island portion 300b, a second supply manifold 51b and a first return manifold 52a1 overlap each other and are in fluid communication with each other via a fifth bypass path 74. In a third island portion 300c, a third supply manifold 51c and a first return manifold 52a2 overlap each other and are in fluid communication with each other via a sixth bypass path 75.

In the first island portion 300a, the first supply manifold 51a is in fluid communication with a first pressure chamber 50a1 of a first individual channel 60a via a first supply narrowed portion 53a1. The first pressure chamber 50a1 is in fluid communication with one end of a first descender 56a1. The first descender 56a1 has a first nozzle orifice 57a1 at the other end thereof. Liquid is allowed to flow into the first pressure chamber 50a1 from the first supply manifold 51a via the first supply narrowed portions 53a1 and to be ejected in droplet form from the first nozzle orifice 57a1 at a certain timing. Liquid not ejected from the first nozzle orifice 57a1 is allowed to flow into the first return manifold 52a1 belonging to the second island portion 300b via the first return narrowed portion 54a1. Some remaining liquid in the second supply manifold 51b that has not flowed into a second individual channel 60b is allowed to flow into the first return manifold 52a1 via the fifth bypass path 74. Liquid in the first return manifold 52a1 is then returned to a corresponding tank 16 via a second outlet 59b.

In the first island portion 300a, the first supply manifold 51a is in fluid communication with a first pressure chamber 50a2 of another first individual channel 60a via a first supply narrowed portion 53a2. The first pressure chamber 50a2 is in fluid communication with one end of a first descender 56a2. The first descender 56a2 has a first nozzle orifice 57a2 at the other end thereof. Liquid is allowed to flow into the first pressure chamber 50a2 from the first supply manifold 51a via the first supply narrowed portion 53a2 and to be ejected in droplet form from the first nozzle orifice 57a2 at a certain timing. Liquid not ejected from the first nozzle orifice 57a2 is allowed to flow into the first return manifold 52a2 belonging to the third island portion 300c via the first return narrowed portion 54a2. Some remaining liquid in the third supply manifold 51c that has not flowed into a third individual channel 60c is allowed to flow into the first return manifold 52a2 via the sixth bypass path 75. Liquid in the first return manifold 52a2 is then returned to a corresponding tank 16 via a third outlet.

In the second island portion 300b, the second supply manifold 51b is in fluid communication with a second pressure chamber 50b of a second individual channel 60b via a second supply narrowed portion 53b. The second pressure chamber 50b is in fluid communication with one end of a second descender 56b. The second descender 56b has a second nozzle orifice 57b at the other end thereof. Liquid is allowed to flow into the second pressure chamber 50b from the second supply manifold 51b via the second supply narrowed portion 53b and to be ejected in droplet form from the second nozzle orifice 57b at a certain timing. Liquid not ejected from the second nozzle orifice 57b is allowed to flow into the second return manifold 52b belonging to the first island portion 300a via the second return narrowed portion 54b.

Liquid is allowed to flow into the second return manifold 52b also from the third island portion 300c as described below. In the third island portion 300c, the third supply manifold 51c is in fluid communication with a third pressure chamber 50c of a third individual channel 60c via a third supply narrowed portion 53c. The third pressure chamber 50c is in fluid communication with one end of a third descender 56c. The third descender 56c has a third nozzle orifice 57c at the other end thereof. Liquid is allowed to flow into the third pressure chamber 50c from the third supply manifold 51c via the third supply narrowed portion 53c and to be ejected in droplet form from the third nozzle orifice 57c at a certain timing. Liquid not ejected from the third nozzle orifice 57c is allowed to flow into the second return manifold 52b belonging to the first island portion 300a via the third return narrowed portion 54c.

Some remaining liquid in the first supply manifold 51a that has not flowed into the first individual channel 60a is allowed to flow into the second return manifold 52b via the first bypass path 70. Liquid in the second return manifold 52b is then returned to a corresponding tank 16 via a first outlet 59a.

According to one or more aspects of the disclosure, a head module may include a plurality of first individual channels 60a, a first supply manifold 51a, a first return manifold 52a, a plurality of second individual channels 60b, a second supply manifold 51b, a second return manifold 52b, and a first bypass path 70. The first individual channels 60a may each include a first nozzle orifice 57a. The first supply manifold 51a may be in fluid communication with the first individual channels 60a and configured to allow liquid to flow into the first individual channels 60a therefrom. The first return manifold 52a may be in fluid communication with the first individual channels 60a and configured to allow liquid not ejected from the first nozzle orifices 57a to flow thereinto. The second individual channels 60b may each include a second nozzle orifice 57b. The second supply manifold 51b may be in fluid communication with the second individual channels 60b and configured to allow liquid to flow into the second individual channels 60b therefrom. The second return manifold 52b may be in fluid communication with the second individual channels 60b and configured to allow liquid not ejected from the second nozzle orifices 57b to flow thereinto. The first bypass path 70 may provide fluid communication between the first supply manifold 51a and the second return manifold 52b.

According to the above configuration, effect of crosstalk caused by pressure wave propagation may be reduced.

According to one or more aspects of the disclosure, in the head module having the above configuration, the head module may have a nozzle surface in which the first nozzle orifices 57a and the second nozzle orifices 57b may be defined. The first bypass path 70 may include a first bypass hole 70a and a first flow path 70b. The first bypass path 70 may be in fluid communication with the second return manifold 52b. The first flow path 70b may overlap the first supply manifold 51a and the first bypass hole 70a when viewed in plan from the nozzle surface. The first flow path 70b may provide fluid communication between the first supply manifold 51a and the first bypass hole 70a.

According to the above configuration, the first bypass path 70 may include the first flow path 70b and the first bypass hole 70a. Thus, pressure to be applied to liquid flowing through the first bypass path 70 may be easily controlled by changing the shapes and sizes of the first flow path 70b and the first bypass hole 70a as appropriate.

According to one or more aspects of the disclosure, in the head module having the above configuration, when it is assumed that a direction toward which the nozzle surface faces is defined as a down direction and a direction opposite to the down direction is defined as an up direction, the first supply manifold 51a may be disposed above the first return manifold 52a and the second supply manifold 51b may be disposed above the second return manifold 52b. The first flow path 70b may include a groove defined in a wall defining the first supply manifold 51a and the second return manifold 52b. The groove may extend from the first supply manifold 51a toward the second return manifold 52b. The first bypass hole 70a may extend in an up-down direction in the wall.

According to the above configuration, the first flow path 70b may be a groove. Thus, when viewed in plan from the nozzle surface, liquid may be allowed to flow between the first supply manifold 51a and the second return manifold 52b in a case where the first supply manifold 51a and the second return manifold 52b are apart from each other. Thus, versatility of arrangement of the first supply manifold 51a and the second return manifold 52b may be increased. Further, pressure to be applied to liquid flowing through the first bypass path 70 may be easily controlled by changing the shape and size of the groove.

According to one or more aspects of the disclosure, in the head module having the above configuration, when it is assumed that a direction toward which the nozzle surface faces is defined as a down direction and a direction opposite to the down direction is defined as an up direction, the first supply manifold 51a may be disposed above the first return manifold 52a and the second supply manifold 51b may be disposed above the second return manifold 52b. The first flow path 70b may include a hole defined in a wall defining the first supply manifold 51a and the second return manifold 52b. The hole may extend in an up-down direction. The first bypass hole 70a may have a smaller diameter than the first flow path 70b and extend in the up-down direction in the wall.

According to the above configuration, the first flow path 70b and the first bypass hole 70a may be holes extending in the wall in the up-down direction. Thus, pressure to be applied to liquid flowing through the first bypass path 70 may be easily controlled by changing the shapes and sizes of the holes. The wall may include a first damper plate 80 and a second damper plate 81. The first damper plate 80 may have the first flow path 70b and the second damper plate 81 may have the first bypass hole 70a. In some cases, the first damper plate 80 and the second damper plate 81 may be laminated with being misaligned relative to each other. Even if such a situation happens, as the first bypass hole 70a has a diameter smaller than the first flow path 70b, liquid may be allowed to flow into the second return manifold 52b from the first supply manifold 51a under at least a certain pressure controlled by the diameter of the first bypass hole 70a.

According to one or more aspects of the disclosure, in the head module having the above configuration, when viewed in plan from the nozzle surface, the first supply manifold 51a and the first return manifold 52a may overlap each other and extend in the same extending direction. The first supply manifold 51a and the first return manifold 52a may have respective different lengths in the extending direction.

According to the above configuration, the first supply manifold 51a and the first return manifold 52a may have the respective different lengths in the extending direction. With this configuration, the first bypass path 70 that may be in fluid communication with the first supply manifold 51a and another bypass path (e.g., the second bypass path 71) that may be in fluid communication with the first return manifold 52a may be positioned at respective different positions without overlapping each other.

According to one or more aspects of the disclosure, in the head module having the above configuration, when viewed in plan from the nozzle surface, the center of the first bypass hole 70a may be on a center line O between and parallel to the first supply manifold 51a and the second return manifold 52b.

According to the above configuration, when viewed in plan from the nozzle surface, the center of the first bypass hole 70a of the first bypass path 70 may be on the center line O between and parallel to the first supply manifold 51a and the second return manifold 52b, both of which extend in the same extending direction. Thus, when the first supply manifold 51a and the second return manifold 52b are viewed in plan, i.e., when viewed in plan from the nozzle surface, a combined shape of the first supply manifold 51a and the first bypass path 70 and the shape of the second return manifold 52b may be substantially symmetric with respect to the center line O. Such a configuration may thus enable a smooth connection of the first supply manifold 51a and the second return manifold 52b. It is assumed that, when viewed in plan from the nozzle surface, the front end portion of one of the first supply manifold 51a and the second return manifold 52b extends straightly in the extending direction. In such a case, the front end portion of the other of the first supply manifold 51a and the second return manifold 52b may need to be bent to connect between the first supply manifold 51a and the second return manifold 52b. Thus, the front portion of the other manifold bending toward the one manifold may be curved sharply to connect to the front end portion of the one manifold. Nevertheless, according to one or more aspects of the disclosure, the center of the first bypass hole 70a of the first bypass path 70 may be on the center line O. Thus, the first supply manifold 51a and the second return manifold 52b may extend so as to approach each other and the first supply manifold 51a and the second return manifold 52b may be connected to each other with both front end portions being curved gently.

According to one or more aspects of the disclosure, the head module above configuration may further include a second bypass path 71 providing fluid communication between the second supply manifold 51b and the first return manifold 52a. The head module may have a nozzle surface in which the first nozzle orifices 57a and the second nozzle orifices 57b may be defined. In such a head module, the second bypass path 71 may include a second bypass hole 71a and a second flow path 71b. The second bypass path 71 may be in fluid communication with the first return manifold 52a. The second flow path 71b may overlap the second supply manifold 51b and the second bypass hole 71a when viewed in plan from the nozzle surface. The second flow path 71b may provide fluid communication between the second supply manifold 51b and the second bypass hole 71a.

According to the above configuration, the head module may further include the second bypass path 71 that may provide fluid communication between the second supply manifold 51b and the first return manifold 52a. Such a configuration may thus provide fluid communication between the first supply manifold 51a and the second return manifold 52b and between the second supply manifold 51b and the first return manifold 52a.

With this configuration, a pressure wave propagating through the first supply manifold 51a may further propagate to the second return manifold 52b, thereby reducing or preventing occurrence of crosstalk that may be caused by merging of a pressure wave propagating through the first supply manifold 51a and a pressure wave propagating through the first return manifold 52a having the same phase as the former pressure wave. Further, a pressure wave propagating through the second supply manifold 51b may further propagate to the first return manifold 52a, thereby reducing or preventing occurrence of crosstalk that may be caused by merging of a pressure wave propagating through the second supply manifold 51b and a pressure wave propagating through the second return manifold 52b having the same phase as the former pressure wave.

In addition, the second flow path 71 may include the second flow path 71b and the second bypass hole 71a. Thus, pressure to be applied to liquid flowing through the second bypass path 71 may be easily controlled by changing the shapes and sizes of the second flow path 71b and the second bypass hole 71a as appropriate.

According to one or more aspects of the disclosure, in the head module above configuration, the first supply manifold 51a may have one end portion having a first inlet 58a allowing liquid to flow into the first supply manifold 51a and the other end portion connecting to the first bypass path 70. The first return manifold 52a may have one end portion having a first outlet 59a allowing liquid to flow out of the first return manifold 52a and the other end portion connecting to the second bypass path 71. The second supply manifold 51b may have one end portion having a second inlet 58b allowing liquid to flow into the second supply manifold 51b and the other end portion connecting to the second bypass path 71. The second return manifold 52b may have one end portion having a second outlet 59b allowing liquid to flow out of the second supply manifold 51b and the other end portion connecting to the first bypass path 70. The first bypass path 70 may include a first bypass hole 70a being in fluid communication with the second return manifold 52b. In such a head module, a distance R₁ from the center of the first inlet 58a to the center of the first bypass hole 70a may be equal to a distance R₂ from the center of the second outlet 59b to the center of the first bypass hole 70a. A distance r₁ from the center of the second inlet 58b to the center of the second bypass hole 71a may be equal to a distance r₂ from the center of the first outlet 59a to the center of the second bypass hole 71a.

According to the above configuration, resistance to be applied to liquid flowing in the channels during manifold circulation may be equalized. Thus, an equal pressure may be applied to both of the first nozzle orifice 57a that may be one of the constituents of the first individual channel 60a and the second nozzle orifice 57b that may be one of the constituents of the second individual channel 60b. Consequently, such a configuration may reduce occurrences of meniscus breaks and variations in a meniscus shape due to locations, thereby reducing liquid ejection variations.

According to one or more aspects of the disclosure, in the head module above configuration, the first bypass path 70 and the second bypass path 71 may be positioned such that the center of the first bypass hole 70a and the center of the second bypass hole 71a may be apart from each other in a direction perpendicular to the extending direction.

In view of prevention of liquid leakage, the first bypass path 70 and the second bypass path 71 may need to be apart from each other by a certain distance. In a case where the center of the first bypass hole 70a and the center of the second bypass hole 71a are aligned with each other in the extending direction, the first bypass hole 70a and the second bypass hole 71a may need to be apart from each other in the extending direction to ensure that the first bypass path 70 and the second bypass path 71 are apart from each other by the certain distance. Such a configuration may however cause increase of the size of the manifolds in the extending direction in the head module.

Nevertheless, according to one or more aspects of the disclosure, the first bypass path 70 and the second bypass path 71 may be positioned such that the center of the first bypass hole 70a and the center of the second bypass hole 71a may be apart from each other in the direction perpendicular to the extending direction. Thus, the first bypass hole 70a and the second bypass hole 71a might not necessarily be apart from each other by a certain distance in the extending direction, thereby reducing the size of the head module.

According to one or more aspects of the disclosure, in the head module having the above configuration, when viewed in plan from the nozzle surface, the first supply manifold 51a and the second return manifold 52b that may be in fluid communication with each other via the first bypass path 70 may be disposed next to each other.

According to the above configuration, when viewed in plan from the nozzle surface, the first supply manifold 51a and the second return manifold 52b that may be in fluid communication with each other via the first bypass path 70 may be disposed next to each other. Such an arrangement may thus enable the first bypass path 70 to have a minimum length, thereby easily connecting between the first supply manifold 51a and the second return manifold 52b for fluid communication.

The first supply manifold 51a and the second return manifold 52b being disposed next to each other when viewed in plan from the nozzle surface may refer to that the first supply manifold 51a and the second return manifold 52b are positioned such that the distance therebetween is shortest and no other manifold is positioned therebetween.

According to one or more aspects of the disclosure, the head module above configuration may further include a first island portion 300a to which the first individual channels 60a belong, and a second island portion 300b disposed next to the first island portion 300a and to which the second individual channels 60b belong. In such a head module, the first supply manifold 51a may belong to the first island portion 300a and the first return manifold 52a may belong to the second island portion 300b.

According to the above configuration, the first individual channel 60a belonging to the first island portion 300a may be in fluid communication with the first supply manifold 51a belonging to the same first island portion 300a and also in fluid communication with the first return manifold 52a belonging to the second island portion 300b located next to the first island portion 300a. As compared with a configuration in which both of the first supply manifold 51a and the first return manifold 52a belong to the same first island portion 300a, the above configuration according to the one or more disclosure may enable a return narrowed portion that may connect between the first individual channel 60a and the first return manifold 52a to be longer, thereby applying a desired level of resistance to liquid flowing through the return narrowed portion.

According to one or more aspects of the disclosure, in the head module having the above configuration, the second supply manifold 51b may belong to the second island portion 300b, and the second return manifold 52b may belong to the first island portion 300a. Each of the first individual channels 60a may include a first return narrowed portion 54a that may be a flow path being in fluid communication with the first return manifold 52a belonging to the second island portion 300b. Each of the second individual channels 60b may include a second return narrowed portion 54b that may be a flow path being in fluid communication with the second return manifold 52b belonging to the first island portion 300a.

According to the above configuration, the adjacent two island portions may be connected to each other via the first return narrowed portion 54a and the second return narrowed portion 54b. Consequently, such a configuration may decrease the required number of individual channels and may enable the individual channels to be arranged at highly populated density as compared with a case where the first individual channel 60a belonging to the first island portion 300a is in fluid communication with the first return manifold 52a via the first return narrowed portion 54a and the second individual channel 60b belonging to the second island portion 300b is in fluid communication with the second return manifold 52b belonging to another island portion different from the first island portion 300a via the second return narrowed portion 54b.

According to one or more aspects of the disclosure, in the head module having the above configuration, the first supply manifold 51a may have a first inlet 58a allowing liquid to flow into the first supply manifold 51a, and the first return manifold 52a may have a first outlet 59a allowing liquid to flow out of the first return manifold 52a. Each of the first individual channels 60a may include a first supply narrowed portion 53a and a first return narrowed portion 54a. The first supply narrowed portion 53a may be a flow path being in fluid communication with the first supply manifold 51a via a first connecting portion 40. The first return narrowed portion 54a may be a flow path being in fluid communication with the first return manifold 52a via a second connecting portion 41. In such a head module, a distance β from the center of the first outlet 59a to the second connecting portion 41 may be equal to a distance α from the center of the first inlet 58a to the first connecting portion 40.

Note that the first supply manifold 51a may be at a positive pressure and the first return manifold 52a may be at a negative pressure.

According to the above configuration, the distance β from the center of the first outlet 59a to the second connecting portion 41 may be equal to the distance α from the center of the first inlet 58a to the first connecting portion 40. Such a configuration may thus easily control pressure to be applied to liquid at the first nozzle orifice 57a of the first individual channel 60a.

According to one or more aspects of the disclosure, in the head module having the above configuration, the first individual channels 60a belonging to the first island portion 300a may be arranged in a row and the second individual channels 60b belonging to the second island portion 300b may be arranged in a row in the same direction as the direction in which the first individual channels 60a may be arranged. In such a head module, the second connecting portion 41 may be disposed between adjacent second individual channels 60b in the second island portion 300b.

According to the above configuration, the second connecting portion 41 may be disposed between adjacent second individual channels 60b belonging to the second island portion 300b. With this arrangement, the first return narrowed portion 54a might not obstruct the arrangement of the second individual channels 60b in the second island portion 300b.

According to one or more aspects of the disclosure, the head module having the above configuration may further include a plurality of third individual channels 60c, a third supply manifold 51c, a third return manifold 52c, a third bypass path 72, and a fourth bypass path 73. The third individual channels 60c may each include a third nozzle orifice 57c. The third supply manifold 51c may be in fluid communication with the third individual channels 60c and configured to allow liquid to flow into the third individual channels 60c. The third return manifold 52c may be in fluid communication with the third individual channels 60c and configured to allow liquid not ejected from the third nozzle orifices 57c to flow thereinto. The third bypass path 72 may provide fluid communication between the second supply manifold 51b and the third return manifold 52c. The fourth bypass path 73 may provide fluid communication between the third supply manifold 51c and the first return manifold 52a. In such a head module, a circulation route may be defined in which liquid flows through at least one of the first individual channels 60a, at least one of the second individual channels 60b, and at least one of the third individual channels 60c.

According to the above configuration, the head module may implement the nozzle circulation and the manifold circulation between three individual channels (e.g., between the first individual channel 60a, the second individual channel 60b, and the third individual channel 60c), and reduce effect of crosstalk caused by pressure wave propagation.

The above configurations may implement the nozzle circulation and the manifold circulation. In order to reduce effect of crosstalk caused by pressure wave propagation, in one example, a bypass path may connect between a supply manifold and a return manifold that may belong to respective different island portions, and in another example, return narrowed portions may belong to respective different island portions. Nevertheless, in other embodiments, for example, a bypass path may connect between particular island portions and a return narrowed portion may connect between other particular island portions.

According to one or more aspects of the disclosure, another head module may include a plurality of first individual channels 60a, a first supply manifold 51a, a first return manifold 52a, a plurality of second individual channels 60b, a second supply manifold 51b, a second return manifold 52b, a plurality of third individual channels 60c, a first island portion 300a, a second island portion 300b, and a third island portion 300c. The first individual channels 60a may each include a first nozzle orifice 57a. The first supply manifold 51a may be in fluid communication with the first individual channels 60a and configured to allow liquid to flow into the first individual channels 60a therefrom. The first return manifold 52a may be in fluid communication with the first individual channels 60a and configured to allow liquid not ejected from the first nozzle orifices 57a to flow thereinto. The second individual channels 60b may each include a second nozzle orifice 57b. The second supply manifold 51b may be in fluid communication with the second individual channels 60b and configured to allow liquid to flow into the second individual channels 60b therefrom. The second return manifold 52b may be in fluid communication with the second individual channels 60b and configured to allow liquid not ejected from the second nozzle orifices 57b to flow thereinto. The third individual channels 60c may each include a third nozzle orifice 57c. The first island portion to which the first individual channels 60a may belong to the first island portion 300a. The second island portion 300b may be disposed next to the first island portion 300a. The second individual channels 60b may belong to the second island portion 300b. The third island portion 300c may be disposed next to the second island portion 300b. The third individual channels 60c may belong to the third island portion 300c.

In such a head module, the first supply manifold 51a may belong to the first island portion 300a and the first return manifold 52a may belong to the second island portion 300b. The second supply manifold 51b may belong to the second island portion 300b and the second return manifold 52b may belong to the third island portion 300c. Each of the first individual channels 60a may include a first return narrowed portion 54a that may be a flow path being in fluid communication with the first return manifold 52a belonging to the second island portion 300b. Each of the second individual channels 60b may include a second return narrowed portion 54b that may be a flow path being in communication with the second return manifold 52b belonging to the third island portion 300c.

According to the above configuration, the first island portion 300a and the second island portion 300b may be connected to each other via the first return narrowed portion 54a, and the second island portion 300b and the third island portion 300c may be connected to each other via the second return narrowed portion 54b.

Such a configuration may thus enable the head module to have more individual channels than a head module in which adjacent two island portions are connected to each other via a first return narrowed portion and a second return narrowed portion. The first island portion 300a and the second island portion 300b may be connected to each other via at least one of the first return narrowed portion 54a or the second return narrowed portion 54b. Thus, less areas may be required for the return narrowed portions.

In order to reduce effect of a pressure wave propagating through the supply manifold and a pressure wave propagating through the return manifold in each island portion, a damper portion may be provided between the supply manifold and the return manifold. Such a configuration may increase the number of individual channels and require less areas for the return narrowed portions connecting between the first island portion 300a and the second island portion 300b, thereby ensuring large areas for damper portions to improve the damper performance.

The disclosure may be applied to, for example, an inkjet printer that may eject liquid droplets onto a sheet from nozzles.

What is claimed is:

1. A head module comprising:
a plurality of first individual channels each including a first nozzle orifice;
a first supply manifold being in fluid communication with the first individual channels and configured to allow liquid to flow into the first individual channels therefrom;
a first return manifold being in fluid communication with the first individual channels and configured to allow liquid not ejected from the first nozzle orifices to flow thereinto;
a plurality of second individual channels each including a second nozzle orifice;
a second supply manifold being in fluid communication with the second individual channels and configured to allow liquid to flow into the second individual channels therefrom;
a second return manifold being in fluid communication with the second individual channels and configured to allow liquid not ejected from the second nozzle orifices to flow thereinto; and
a first bypass path providing fluid communication between the first supply manifold and the second return manifold.

2. The head module according to claim 1,
wherein the head module has a nozzle surface in which the first nozzle orifices and the second nozzle orifices are defined, and
wherein the first bypass path includes:
a first bypass hole being in fluid communication with the second return manifold; and
a first flow path overlapping the first supply manifold and the first bypass hole when viewed in plan from the nozzle surface, and providing fluid communication between the first supply manifold and the first bypass hole.

3. The head module according to claim 2,
wherein, when it is assumed that a direction toward which the nozzle surface faces is defined as a down direction and a direction opposite to the down direction is defined as an up direction, the first supply manifold is disposed above the first return manifold and the second supply manifold is disposed above the second return manifold,
wherein the first flow path includes a groove defined in a wall defining the first supply manifold and the second return manifold, wherein the groove extends from the first supply manifold toward the second return manifold, and
wherein the first bypass hole extends in an up-down direction in the wall.

4. The head module according to claim 2,
wherein, when it is assumed that a direction toward which the nozzle surface faces is defined as a down direction and a direction opposite to the down direction is defined as an up direction, the first supply manifold is disposed above the first return manifold and the second supply manifold is disposed above the second return manifold,
wherein the first flow path includes a hole defined in a wall defining the first supply manifold and the second return manifold, wherein the hole extends in an up-down direction, and
wherein the first bypass hole has a smaller diameter than the first flow path and extends in the up-down direction in the wall.

5. The head module according to claim 2,
wherein when viewed in plan from the nozzle surface, the first supply manifold and the first return manifold overlap each other and extend in the same extending direction, and
wherein the first supply manifold and the first return manifold have respective different lengths in the extending direction.

6. The head module according to claim 5,
wherein when viewed in plan from the nozzle surface, the center of the first bypass hole is on a center line between and parallel to the first supply manifold and the second return manifold.

7. The head module according to claim 1, further comprising a second bypass path providing fluid communication between the second supply manifold and the first return manifold,
wherein the head module has a nozzle surface in which the first nozzle orifices and the second nozzle orifices are defined, and
wherein the second bypass path include:
a second bypass hole being in fluid communication with the first return manifold; and
a second flow path overlapping the second supply manifold and the second bypass hole when viewed in plan from the nozzle surface, and providing fluid communication between the second supply manifold and the second bypass hole.

8. The head module according to claim 7,
wherein the first supply manifold has one end portion having a first inlet allowing liquid to flow into the first supply manifold and the other end portion connecting to the first bypass path,
wherein the first return manifold has one end portion having a first outlet allowing liquid to flow out of the first return manifold and the other end portion connecting to the second bypass path,
wherein the second supply manifold has one end portion having a second inlet allowing liquid to flow into the second supply manifold and the other end portion connecting to the second bypass path,
wherein the second return manifold has one end portion having a second outlet allowing liquid to flow out of the second supply manifold and the other end portion connecting to the first bypass path,
wherein the first bypass path includes a first bypass hole being in fluid communication with the second return manifold,
wherein a distance from the center of the first inlet to the center of the first bypass hole is equal to a distance from the center of the second outlet to the center of the first bypass hole, and
wherein a distance from the center of the second inlet to the center of the second bypass hole is equal to a distance from the center of the first outlet to the center of the second bypass hole.

9. The head module according to claim 8,
wherein when viewed in plan from the nozzle surface, the first supply manifold and the first return manifold overlap each other and the second supply manifold and the second return manifold overlap each other,
wherein the first supply manifold, the first return manifold, the second supply manifold, and the second return manifold extend in the same extending direction, and
wherein the first bypass path and the second bypass path are positioned such that the center of the first bypass hole and the center of the second bypass hole are apart from each other in a direction perpendicular to the extending direction.

10. The head module according to claim 1,
wherein when viewed in plan from the nozzle surface, the first supply manifold and the second return manifold that are in fluid communication with each other via the first bypass path are disposed next to each other.

11. The head module according to claim 1, further comprising:
a first island portion to which the first individual channels belong; and
a second island portion disposed next to the first island portion and to which the second individual channels belong,
wherein the first supply manifold belongs to the first island portion and the first return manifold belongs to the second island portion.

12. The head module according to claim 11,
wherein the second supply manifold belongs to the second island portion,
wherein the second return manifold belongs to the first island portion, wherein each of the first individual channels includes a first return narrowed portion that is a flow path being in fluid communication with the first return manifold belonging to the second island portion, and
wherein each of the second individual channels includes a second return narrowed portion that is a flow path being in fluid communication with the second return manifold belonging to the first island portion.

13. The head module according to claim 11,
wherein the first supply manifold has a first inlet allowing liquid to flow into the first supply manifold,
wherein the first return manifold has a first outlet allowing liquid to flow out of the first return manifold,
wherein each of the first individual channels includes:
a first supply narrowed portion that is a flow path being in fluid communication with the first supply manifold via a first connecting portion,
a first return narrowed portion that is a flow path being in fluid communication with the first return manifold via a second connecting portion, and
wherein a distance from the center of the first outlet to the second connecting portion is equal to a distance from the center of the first inlet to the first connecting portion.

14. The head module according to claim 13,
wherein the first individual channels belonging to the first island portion are arranged in a row and the second individual channels belonging to the second island portion are arranged in a row in the same direction as the direction in which the first individual channels are arranged, and
wherein the second connecting portion is disposed between adjacent second individual channels in the second island portion.

15. The head module according to claim 1, further comprising:
a plurality of third individual channels;
a third supply manifold being in fluid communication with the third individual channels and configured to allow liquid to flow into the third individual channels;
a third return manifold being in fluid communication with the third individual channels and configured to allow liquid not ejected from the third nozzle orifices to flow thereinto;
a third bypass path providing fluid communication between the second supply manifold and the third return manifold; and
a fourth bypass path providing fluid communication between the third supply manifold and the first return manifold,
wherein a circulation route is defined in which liquid flows through at least one of the first individual channels, at least one of the second individual channels, and at least one of the third individual channels.

16. A head module, comprising:
a plurality of first individual channels each including a first nozzle orifice;
a first supply manifold being in fluid communication with the first individual channels and configured to allow liquid to flow into the first individual channels therefrom;
a first return manifold being in fluid communication with the first individual channels and configured to allow liquid not ejected from the first nozzle orifices to flow thereinto;
a plurality of second individual channels each including a second nozzle orifice;
a second supply manifold being in fluid communication with the second individual channels and configured to allow liquid to flow into the second individual channels therefrom;
a second return manifold being in fluid communication with the second individual channels and configured to allow liquid not ejected from the second nozzle orifices to flow thereinto;
a plurality of third individual channels each including a third nozzle orifice;
a first island portion to which the first individual channels belong;
a second island portion disposed next to the first island portion and to which the second individual channels belong; and
a third island portion disposed next to the second island portion and to which the third individual channels belong,
wherein the first supply manifold belongs to the first island portion and the first return manifold belongs to the second island portion,
wherein the second supply manifold belongs to the second island portion and the second return manifold belongs to the third island portion,
wherein each of the first individual channels includes a first return narrowed portion that is a flow path being in fluid communication with the first return manifold belonging to the second island portion, and
wherein each of the second individual channels includes a second return narrowed portion that is a flow path being in communication with the second return manifold belonging to the third island portion.
